(19) United States
(12) Patent Application Publication
(10) Pub. No.: US 2026/0333546 A1
(43) Pub. Date: Oct. 22, 2026

(54) LIGHTING-BASED VISUAL PRODUCTION PICK-UP, AND METHOD AND SYSTEM FOR CONTROLLING LIGHTING DEVICES BASED ON REMOTE ENVIRONMENT OPTIMIZATION THEREOF

(71) Applicant: HYBE CO., Ltd., Seoul (KR)

(72) Inventors: Bo Yoon CHOI, Seoul (KR); Ji Yeon Lee, Seoul (KR)

(21) Appl. No.: 19/649,741

(22) Filed: Apr. 16, 2026

(30) Foreign Application Priority Data
Apr. 22, 2025 (KR) 10-2025-0052602
Aug. 7, 2025 (KR) 10-2025-0109236
Nov. 26, 2025 (KR) 10-2025-0182180

(51) Int. Cl. H05B 47/135; G06V 10/60; G06V 10/774; H05B 47/16; H05B 47/165; H05B 47/175; H05B 47/19

(52) U.S. Cl. CPC H05B 47/135; G06V 10/60; G06V 10/774; H05B 47/16; H05B 47/165; H05B 47/19; H05B 47/1965; H05B 47/1985

(57) ABSTRACT

Described is a computing system that captures on-site lighting-device visual production from video data acquired by an AI camera. The system identifies individual lighting devices using an image analysis model trained with shape information, rendering color code information, and device identification information. The system extracts lighting pattern information, time-stamps the lighting pattern information as pick-up information, and allows correction through a lighting pattern management interface. The system converts the pick-up information and/or on-site visual production data into remote location visual production data optimized for a remote venue and transmits a control signal through a repeater so that remote lighting devices emit light in synchronization with a streamed performance video.

### CROSS-REFERENCE TO RELATED APPLICATIONS

This application claims priority of the Korean Patent Applications No. 10-2025-0052602, filed on Apr. 22, 2025, No. 10-2025-0109236, filed on Aug. 07, 2025, and No. 10-2025-0182180, filed on Nov. 26, 2025, in the Korean Intellectual Property Office. The entire disclosures of all these applications are hereby incorporated by reference.

### TECHNICAL FIELD

The present disclosure relates to a method and a system for capturing, using an AI camera, a lighting-device-based visual production implemented on-site and controlling a plurality of lighting devices located on-site or at a plurality of remote screening venues to emit light in a manner corresponding to the on-site lighting-device-based visual production.

### BACKGROUND ART

Lighting devices are designed to render various colors and to produce vivid effects in dark spaces, and are utilized not only as cheering tools at concerts and showcases, but also for night activities and various events such as sports events, festivals, and parades.

Recently, lighting devices have evolved beyond simple cheering tools. Multiple lighting devices may form specific letters or shapes together. Further, an administrator may perform control over lighting devices held by individuals to implement diverse visual productions during events.

In particular, with the global popularity of K-POP, live services that screen artists' concerts in real time at remote locations, such as movie theaters, have become increasingly active, and efforts have been made to utilize centrally controlled lighting devices to reproduce the on-site experience at remote locations.

However, such lighting devices are still used only in concert halls as part of performance production. Further, when the performance location changes or when a relatively small number of people gather compared with a full-scale concert audience, use of the lighting devices is difficult because of transmission-distance limitations, spatial limitations, and the absence of an administrator.

Moreover, even when complex performance direction is not required, at least one operator for executing the visual production must be stationed at a separate location (e.g., a predetermined remote location separate from the actual performance hall), thereby wasting human resources.

Existing remote location visual production methods remain at the level of simply controlling lighting for all seats collectively or reproducing simple lighting patterns. As a result, there is a limitation in realizing at remote locations the diversity of an actual performance where tens of thousands of seats operate organically. In particular, because the on-site performance venue and the remote screening venues differ in seat arrangement and scale, substantial time and cost are required to manually reprocess the on-site visual production data according to the remote environments, and it is also difficult to accurately reflect the director's intention.

In addition, there are frequent situations that hinder the experience of viewers, such as visual production desynchronization, depending on repeater equipment or network conditions at each remote location.

Therefore, there is an urgent need for technical improvements that enable on-site lighting patterns to be extracted (picked up) in real time using an AI camera and be automatically optimized and converted according to various types of remote environments, while also allowing the status of multiple remote locations to be centrally monitored and enabling precise synchronization between video and visual production without specialized personnel.

### Prior Art Literature

### Patent Document

(Patent Document 1) KR 10-2669121 B1

(Patent Document 2) KR 2402370 B1

(Patent Document 3) KR 2097751 B1

### Disclosure

### Technical Problem

An embodiment of the present disclosure has been devised to solve the above-described problems of the prior art, and an object of the present disclosure is to provide a method and system for controlling lighting devices that capture lighting devices installed on-site, extract lighting patterns, sequentially accumulate the extracted lighting patterns, and transmit, as control signals, the accumulated lighting patterns in synchronization with a timecode of a video played at a remote location.

Another object of the present disclosure is to provide a method and a system for controlling lighting devices, wherein an image analysis model is pre-trained on a shape of each cheering tool and a rendering color code rendered by each cheering tool.

Another object of the present disclosure is to provide a method and a system for controlling lighting devices capable of capturing lighting patterns in which a plurality of lighting devices respectively paired with different seats emit light with a time lag.

Another object of the present disclosure is to provide a method and a system for controlling lighting devices capable of providing a lighting pattern management interface that enables correction of pickup data accumulated in real time before a streaming time point.

Another object of the present disclosure is to provide a method and a system for controlling lighting devices capable of automatically scaling and resampling pickup data based on physical seat-arrangement and scale information at remote locations.

Another object of the present disclosure is to provide a method and a system for controlling lighting devices capable of providing an integrated dashboard that identifies streaming status at various remote locations and controls visual productions based on a playlist.

However, the objects to be achieved by the present disclosure are not limited to the above-described objects, and other objects will be apparent from the following description.

### Technical Solution

A method for a computing system to control lighting devices according to an embodiment of the present disclosure comprises: obtaining video data including shape information and rendering color code information of each of a plurality of lighting devices respectively paired with different seats; storing a dataset by associating the shape information and the rendering color code information with device identification information of each of the lighting devices; training an image analysis model configured to, when the video data is input, extract the shape information and the rendering color code information and output the device identification information using the dataset; automatically determining the device identification information of each of the plurality of lighting devices by applying the image analysis model to the video data; extracting lighting pattern information corresponding to the determined device identification information, wherein the lighting pattern information includes at least one of a color parameter, a brightness parameter, and an effect parameter; accumulating the lighting pattern information as pick-up information by matching the lighting pattern information with a time stamp indicating a pick-up time point for the extracted lighting pattern information; correcting at least one parameter of the accumulated pick-up information through a lighting pattern management interface; and transmitting, to the plurality of lighting devices, a control signal including an instruction for causing the lighting devices to emit light based on the corrected pick-up information, through a repeater located at a remote location.

Further, the lighting pattern information may include the color parameter, an HSL parameter, and the effect parameter, and at least one of a lighting color, a lighting duration, a lighting brightness, and a lighting effect may be indicated based on the plurality of parameters.

Further, the image analysis model may be pre-trained using a dataset including the shape information of each lighting device mapped with a rendering color code pre-defined corresponding to the shape, and the training of the image analysis model may further include: setting, as a commercial tag, lighting pattern information extracted a preset number of times or more for a first lighting device among the plurality of lighting devices; and pre-training the image analysis model based on the commercial tag.

Further, the control signal may include a device ID, and the plurality of lighting devices receiving the control signal from the repeater located at the remote location may be configured to emit light in response to the control signal only when the device IDs thereof pre-stored therein match the device ID included in the control signal.

Further, the lighting pattern management interface may be configured to: display a timeline view representing lighting pattern information for each pick-up time point accumulated in chronological order, on a time axis; highlight the pick-up information when a difference value between the pick-up information and pre-stored standard data exceeds a threshold value; and provide a correction value automatically determined by at least one artificial intelligence model based on a preset rendering color code when the highlighted pick-up information is selected.

Further, the transmitting of the control signal to the plurality of lighting devices may include: extracting a local time stamp included in the pick-up information; extracting a streaming time stamp mapped to a live video played at a remote location; calculating a synchronization time point by calculating an offset between the extracted local time stamp and streaming time stamp; and transmitting the control signal at the calculated synchronization time point.

A method for a computing system to control lighting devices according to an embodiment of the present disclosure comprises: obtaining on-site seat information for an on-site performance; obtaining remote location seat information for a first remote location where the on-site performance is streamed; determining and displaying at least one target seat where visual production to be applied to the first remote location is performed among the on-site seat information; converting on-site visual production data for the at least one target seat into remote location visual production data optimized for the first remote location; and remotely controlling a repeater located at each of at least one remote location including the first remote location based on the converted remote location visual production data.

Further, the determining and displaying of the at least one target seat may include: analyzing a shape similarity between at least a portion of the on-site seat information and the remote location seat information, wherein the shape similarity is based on at least one of an angle of each remote location seat, a number of seats, a seat density of a remote location block including a plurality of remote location seats, and a horizontal-to-vertical ratio; and determining, as the target seats, seats included in a first block having a shape similarity equal to or greater than a preset ratio among a plurality of candidate blocks in the on-site seat information, wherein a block is a set of at least two seats.

Further, the converting of the on-site visual production data for the at least one target seat into the remote location visual production data may include performing a visual production shape scaling operation by comparing seat parameters of an on-site block including the at least one target seat for the on-site performance with seat parameters of a remote location block including a plurality of seats for a remote location performance, and the seat parameters may include at least one of a number of seats, a number of rows, and a number of columns of the on-site seat information or the remote location seat information.

Further, the performing of the visual production shape scaling operation may include: calculating a resampling ratio based on a difference between the seat parameters of the on-site block and the remote location block; and proportionally deleting or duplicating at least a portion of row data or column data included in the on-site visual production data according to the calculated resampling ratio.

Further, the performing of the visual production shape scaling operation may further include: extracting, from the on-site visual production data, visual production values of data associated with seats adjacent to seats corresponding to the deleted or duplicated row or column data; and generating the remote location visual production data by performing correction on the on-site visual production data based on the extracted visual production values, and the visual production value associated with each adjacent seat may include at least one of a lighting color, a lighting brightness, and a lighting effect of a lighting device corresponding to the seat and configured to emit light according to the visual production data.

Further, the converting of the on-site visual production data for the at least one target seat into the remote location visual production data may include: mapping a plurality of seats within an on-site block including the at least one target seat to a plurality of seats within a remote location block in a 1:1 manner; and generating the remote location visual production data by applying a visual production value of each of the plurality of seats within the on-site block to a visual production value of corresponding one of the plurality of seats within the remote location block based on the 1:1 mapping, and section control for manifesting a visual production pattern of the on-site block at the remote location block may be set in the remote location visual production data based on the 1:1 mapping.

Further, the converting of the on-site visual production data for the at least one target seat into the remote location visual production data may include: detecting a dark interval included in on-site visual production data of a single seat; generating a visual production correction value based on a duration of the detected dark interval and visual production values immediately before and after the dark interval; and generating the remote location visual production data by replacing the dark interval with the visual production correction value.

Further, the generating of the remote location visual production data by replacing the dark interval with the visual production correction value may include: determining the lighting-based visual production value immediately before the dark interval as a first visual production value; determining the lighting-based visual production value immediately after the dark interval as a second visual production value; generating a visual production correction value for continuously transitioning from the first visual production value to the second visual production value over the entire duration of the dark interval; and generating the remote location visual production data by replacing the dark interval with the generated visual production correction value.

A system for controlling lighting devices according to an embodiment of the present disclosure comprises: a central control terminal operatively coupled to at least one AI camera ; at least one repeater; and at least one lighting device, wherein the central control terminal includes: at least one memory; and at least one processor configured to read at least one application stored in the memory and control the plurality of lighting devices using the AI camera, wherein the processor of the central control terminal is configured to operate in response to instructions for: obtaining video data including shape information and rendering color code information of each of the plurality of lighting devices respectively paired with different seats; storing a dataset by associating the shape information and the rendering color code information with device identification information of each of the lighting devices; training an image analysis model configured to, when the video data is input, extract the shape information and the rendering color code information and output the device identification information using the dataset; automatically determining the device identification information of each of the plurality of lighting devices by applying the image analysis model to the video data; extracting lighting pattern information corresponding to the determined device identification information, wherein the lighting pattern information includes at least one of a color parameter, a brightness parameter, and an effect parameter; accumulating the lighting pattern information as pick-up information by matching the lighting pattern information with a time stamp indicating a pick-up time point for the extracted lighting pattern information; obtaining on-site seat information for an on-site performance and remote location seat information for a first remote location where the on-site performance is streamed; determining and displaying at least one target seat where visual production to be applied to the first remote location is performed among the on-site seat information; converting on-site visual production data for the at least one target seat or the pick-up information into remote location visual production data optimized for the first remote location; correcting at least one parameter of the accumulated pick-up information through a lighting pattern management interface; and transmitting, to the plurality of lighting devices, a control signal including an instruction for causing the lighting devices to emit light based on the corrected pick-up information or the remote location visual production data, through a repeater located at a remote location.

Further, the repeater may include: a receiver configured to obtain at least one of the remote location visual production data, a streaming video, and a lighting-based visual production control signal corresponding to the streaming video from the central control terminal or a server connected to the central control terminal; and a transmitter configured to transmit, to the terminal or a server connected to thereto, playback status information for the streaming video and the lighting-based visual production control signal.

Further, the repeater may be configured to generate a trigger signal and transmit the trigger signal to the central control terminal or the server connected to the central control terminal when a preset abnormal signal is detected in the playback status information.

Further, the application may be configured to: display, on an administrator interface, status information of the repeater that transmitted the trigger signal as an ‘alert’ upon receiving the trigger signal from the repeater; and perform at least one remote control operation selected from power control, network reconnection, and sync control for the repeater associated with the displayed ‘alert’.

Further, the repeater may be configured to obtain a remote control command including a sync control command for performing synchronization between a current playback time point of the streaming video and a current transmission time point of the lighting-based visual production control signal.

### Advantageous Effects

The method and the system for controlling lighting devices according to an embodiment of the present disclosure may capture lighting devices installed on-site to extract lighting patterns, sequentially accumulate the extracted lighting patterns, and transmit, as control signals, the accumulated patterns synchronized with a timecode of a video played at a remote location, thereby reproducing, at the remote location and with the same timing, lighting color, brightness, and effects manifested on-site, thus maximizing immersion and realism in performance production.

In addition, the method and the system for controlling lighting devices according to an embodiment of the present disclosure may perform pre-training on a shape of each cheering tool and a rendering color code rendered by each cheering tool, thereby supporting a stable and consistent lighting effect even when various types of devices coexist.

In addition, the method and the system for controlling lighting devices according to an embodiment of the present disclosure may capture lighting patterns in which a plurality of lighting devices respectively paired with different seats emit light with a time lag, thereby accurately converting sequential visual productions (e.g., audience wave and sequential lighting) occurring in various areas into data and synchronizing the same with remote location streaming data, and thus, naturally reproducing the visual production timeline for each seat.

In addition, the method and the system for controlling lighting devices according to an embodiment of the present disclosure may provide a lighting pattern management interface that enables correction of pick-up data accumulated in real time before a streaming time point, so that an administrator may check and supplement a lighting pattern or video information including lighting color, brightness, and effect in advance, thereby enhancing the completeness of performance data to be finally transmitted, and reflecting a desired special effect or color correction according to a planning intention.

In addition, the method and the system for controlling lighting devices according to an embodiment of the present disclosure may automatically scale and resample pick-up data based on physical seat arrangement and scale information at remote locations, thereby ensuring optimized visual production quality from small screening venues to large stadiums.

In addition, the method and the system for controlling lighting devices according to an embodiment of the present disclosure may provide an integrated dashboard capable of identifying streaming status at various remote locations and controlling visual productions based on a playlist, thereby enabling immediate and flexible responses even when errors occur at remote locations and minimizing time, manpower, and economic losses required for solving problems.

However, effects obtainable in the present disclosure are not limited to the effects mentioned above, and other effects not mentioned may be clearly understood from the following description.

### DESCRIPTION OF DRAWINGS

FIG. 1 is a conceptual diagram of a remote location lighting control system according to an embodiment of the present disclosure.

FIG. 2 is an internal block diagram of a central control terminal according to an embodiment of the present disclosure.

FIG. 3 is an internal block diagram of a lighting device according to an embodiment of the present disclosure.

FIG. 4 is an internal block diagram of a repeater according to an embodiment of the present disclosure.

FIGS. 5 and 6 are flowcharts illustrating a method for providing a remote-location lighting control service using an AI camera, according to an embodiment of the present disclosure.

FIG. 7 is an example diagram schematically illustrating a setup site according to an embodiment of the present disclosure.

FIG. 8 is an example diagram illustrating pick-up information according to an embodiment of the present disclosure.

FIG. 9 is an example diagram illustrating a lighting pattern management interface according to an embodiment of the present disclosure.

FIG. 10 is a flowchart illustrating a method for converting on-site visual production data into remote-location visual production data according to an embodiment of the present disclosure.

FIG. 11 is an example of a visual production interface in which a seat list is displayed according to an embodiment of the present disclosure.

FIG. 12 is an example of a visual production interface in which candidate blocks are displayed according to an embodiment of the present disclosure.

FIGS. 13 and 14 are examples of diagrams for illustrating visual production shape scaling according to an embodiment of the present disclosure.

FIG. 15 is a flowchart illustrating a visual production shape scaling operation process according to an embodiment of the present disclosure.

FIGS. 16 and 17 are examples of diagrams for illustrating an integrated dashboard function of an administrator interface according to an embodiment of the present disclosure.

FIGS. 18 and 19 are examples of diagrams for illustrating a repeater management function of an administrator interface according to an embodiment of the present disclosure.

FIG. 20 is a conceptual diagram for illustrating a sync process according to an embodiment of the present disclosure.

### DETAILED DESCRIPTION OF THE EMBODIMENTS

The present disclosure may be variously modified and may have various embodiments, and thus specific embodiments are illustrated in the drawings and described in detail in the following detailed description. The effects and features of the present disclosure, as well as methods for achieving them, will become apparent with reference to the embodiments described below in detail in association with the accompanying drawings. However, the present disclosure is not limited to the embodiments disclosed below and may be implemented in various forms. In the following embodiments, terms such as “first” and “second” are used not in a limiting sense but for the purpose of distinguishing one component from another. In addition, singular expressions include plural expressions unless the context clearly indicates otherwise. Further, terms such as “include” or “have” indicate the presence of the stated features or components described herein and do not preclude the possibility that one or more other features or components may be added. In the drawings, components may be exaggerated or reduced in size for the convenience of description. For example, the sizes and thicknesses of components shown in the drawings are arbitrarily illustrated for convenience of explanation, and thus the present disclosure is not necessarily limited to the illustrated representations.

Hereinafter, embodiments of the present disclosure will be described in detail with reference to the accompanying drawings. When describing the embodiments with reference to the drawings, identical or corresponding components will be denoted by the same reference numerals, and redundant descriptions thereof will be omitted.

Hereinafter, an exemplary system (hereinafter, referred to as a remote location lighting control system) that implements a service (hereinafter, referred to as a remote location lighting control service) that captures a lighting device-based visual production implemented on-site using an AI camera and controls a plurality of lighting devices to emit light in the same manner according to the lighting device-based visual production implemented on-site will be described in detail with reference to the accompanying drawings.

In an embodiment, the remote location lighting control system may further include a visual production data conversion service and a live service in addition to the remote location lighting control service.

The visual production data conversion service is a service that converts visual production data for each seat used in an on-site performance venue to suit a reduced environment, such as a screening venue at a remote location.

The live service refers to a service through which a live performance is remotely provided at each remote location.

In an embodiment, the term “remote location” may refer to a location other than a site where the actual performance is performed, and may be a private space, such as a house, and/or a public place, such as a theater or a cinema. At the remote location, a performance video may be streamed in real time, and the lighting-based visual production may be implemented identically.

In addition, the remote location lighting control service may not be provided only through real-time streaming, but may also be provided when playing back a video of the performance stored on a predetermined recording medium (e.g., a CD, a DVD, an HD-DVD, a Blu-ray DISC, etc.) after the performance has ended.

In detail, the remote location lighting control service according to an embodiment identifies a lighting pattern (e.g., a color and an effect) of a lighting device that is instantaneously or continuously captured and extracted by an AI camera and controls transmission of a control signal including the identified lighting pattern to a repeater located at a remote location. This enables lighting control the lighting devices even at the remote location where an on-site operator, such as a director/performer, is absent.

Hereinafter, for convenience of description, an operation of extracting lighting patterns of a plurality of lighting devices set on-site using an AI camera will be referred to as a "pick-up".

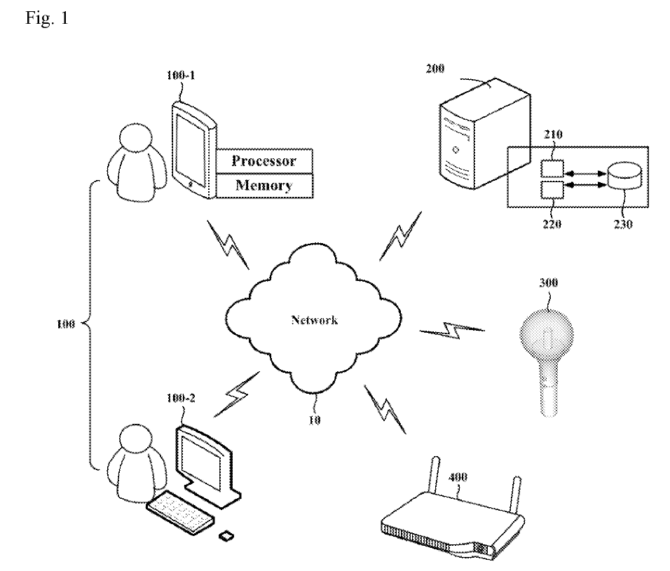

FIG. 1 is a conceptual diagram of a remote location lighting control system according to an embodiment of the present disclosure.

Referring to FIG. 1, the remote location lighting control system implementing the remote location lighting control service may be connected to a central control terminal 100, a service providing server 200, a lighting device 300, and a repeater 400 via a network 10.

In this regard, the network 10 according to an embodiment refers to a connection structure through which information can be exchanged among respective nodes, such as the central control terminal 100, the service providing server 200, the lighting device 300, the repeater 400, and the like. Examples of such a network 10 include a 3rd generation partnership project (3GPP) network, a long term evolution (LTE) network, a world interoperability for microwave access (WIMAX) network, the Internet, a local area network (LAN), a wireless local area network (wireless LAN), a wireless area network (WAN), a personal area network (PAN), a Bluetooth network, a satellite broadcasting network, an analog broadcasting network, a digital multimedia broadcasting (DMB) network, and the like, but are not limited thereto.

Hereinafter, the central control terminal 100, the service providing server 200, the lighting device 300, and the repeater 400 implementing the remote location lighting control system will be described in detail with reference to the accompanying drawings.

### Central control terminal 100

The central control terminal 100, according to an embodiment of the present disclosure, may be a predetermined computing device in which a remote location lighting control application (hereinafter, referred to as an application) providing the remote location lighting control service is installed.

Specifically, from a hardware perspective, the central control terminal 100 may include a mobile-type computing device 100-1 and/or a desktop-type computing device 100-2 in which the application is installed.

In this regard, the mobile-type computing device 100-1 may be a mobile device such as a smartphone or a tablet PC in which the application is installed.

For example, the mobile-type computing device 100-1 may include a smart phone, a mobile phone, a digital broadcasting device, a personal digital assistant (PDA), a portable multimedia player (PMP), a tablet personal computer (PC), and the like.

In addition, the desktop-type computing device 100-2 may include a device in which a program for executing the remote location lighting control service based on wired/wireless communication is installed, such as a personal computer including a fixed desktop PC, a laptop computer, an Ultrabook, and the like, in which the application is installed.

Further, depending on the embodiments, the central control terminal 100 may include a predetermined server computing device that provides a remote-location lighting control service environment.

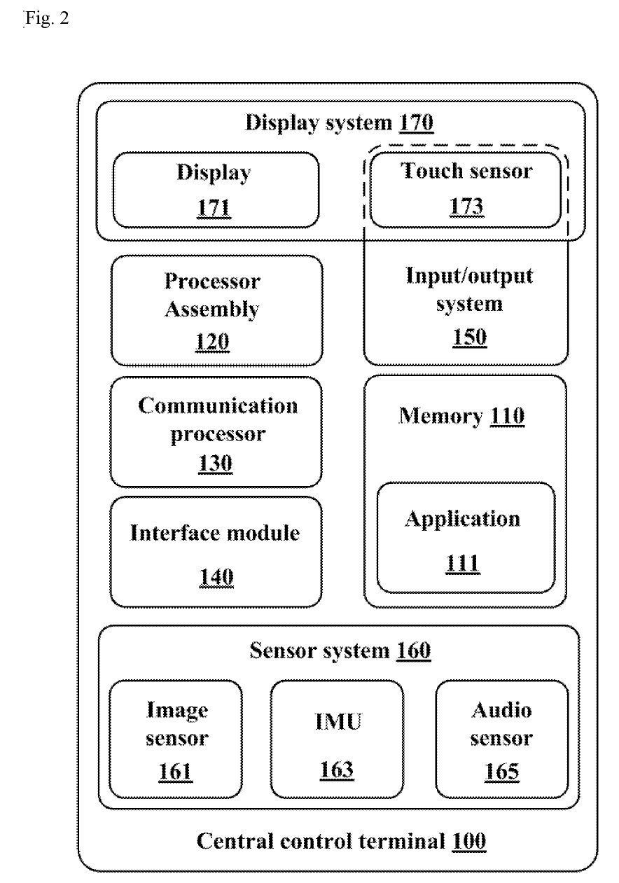

FIG. 2 is an internal block diagram of a central control terminal according to an embodiment of the present disclosure.

Referring to FIG. 2, from a functional perspective, the central control terminal 100 may include a memory 110, a processor assembly 120, a communication processor 130, an interface module 140, an input system 150, a sensor system 160, and a display system 170. These components may be configured to be included within a housing of the central control terminal 100.

In detail, an application 111 may be stored in the memory 110, and the application 111 may store one or more of various application programs, data, and instructions for providing the remote location lighting control service environment.

That is, the memory 110 may store commands, data, and the like that may be used to generate the remote location lighting control service environment.

In addition, the memory 110 may include a program area and a data area.

In this regard, the program area, according to an embodiment, may be positioned between and associated with an operating system (OS) for booting the central control terminal 100 and functional elements, and the data area may store data generated according to the use of the central control terminal 100.

In addition, the memory 110 may include at least one non-transitory computer-readable storage medium and a transitory computer-readable storage medium.

For example, the memory 110 may be various storage devices such as a ROM, an EPROM, a flash drive, and a hard drive, or may include web storage that performs a storage function of the memory 110 on the Internet.

The processor assembly 120 may include at least one processor capable of executing the instructions of the application 111 stored in the memory 110 to perform various tasks for generating the remote location lighting control service environment.

In an embodiment, the processor assembly 120 may control overall operation of the components through the application 111 of the memory 110 to provide the remote location lighting control service.

Such a processor assembly 120 may be a system-on-chip (SOC) suitable for the central control terminal 100 including a central processing unit (CPU) and/or a graphic processing unit (GPU), may execute the operating system (OS) and/or the application program stored in the memory 110, and may control each component mounted in the central control terminal 100.

Further, the processor assembly 120 may be in communication with each component internally via a system bus, and may include one or more predetermined bus structures, including a local bus.

In addition, the processor assembly 120 may be implemented to include at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and an electrical unit for performing other functions.

The communication processor 130 may include one or more devices for establishing communication with an external device. Such a communication processor 130 may establish communication over a wireless network.

Specifically, the communication processor 130 may be in communication with a terminal storing a content source for implementing the remote location lighting control service environment, and may be in communication with various user input components, such as a controller that receives a user input.

In an embodiment, the communication processor 130 may transmit and receive various data related to the remote location lighting control service to and from another terminal and/or an external server.

Such a communication processor 130 may wirelessly transmit and receive data to and from at least one of a base station, an external terminal, and an arbitrary server on a mobile communication network established through a communication device capable of supporting technical standards or communication schemes for mobile communication (e.g., long term evolution (LTE), long term evolution-advanced (LTE-A), 5G new radio (NR), and WIFI), or short-range communication schemes.

The interface module 140 may communicatively connect the central control terminal 100 to one or more other devices. Specifically, the interface module 140 may include wired and/or wireless communication devices compatible with one or more different communication protocols.

The central control terminal 100 may be connected to several input/output devices through such an interface module 140.

For example, the interface module 140 may be connected to an audio output device such as a headset port or a speaker and output audio.

Although the audio output device is described as being connected through the interface module 140, an embodiment in which the audio output device is installed inside the central control terminal 100 may also be included.

In addition, for example, the interface module 140 may be connected to an input device such as a keyboard and/or a mouse and obtain a user input.

Such an interface module 140 may be configured to include at least one of a wired/wireless headset port, an external charger port, a wired/wireless data port, a memory card port, a port for connecting a device having an identification module, an audio input/output (I/O) port, a video input/output (I/O) port, an earphone port, a power amplifier, an RF circuit, a transceiver, and other communication circuits.

The input system 150 may sense a user input (e.g., a gesture, a voice command, a manipulation of a button, or other types of input) related to the remote location lighting control service.

In detail, the input system 150 may include a predetermined button, a touch sensor, and/or an image sensor 161 that receives a user motion input.

In addition, the input system 150 may be connected to an external controller through the interface module 140 and receive a user input.

The sensor system 160 may include various sensors such as the image sensor 161, an IMU 163, an audio sensor 165, a distance sensor, a proximity sensor, and a contact sensor.

In this regard, the image sensor 161 may capture an image and/or a video of a physical space around the central control terminal 100.

In an embodiment, the image sensor 161 may capture and obtain various images and/or videos related to the remote location lighting control service.

In addition, the image sensor 161 may be disposed on a front surface and/or a rear surface of the central control terminal 100 to obtain a video by capturing a space in a direction in which the image sensor 161 is oriented, and may capture a physical space through a camera disposed to face an exterior of the central control terminal 100.

Such an image sensor 161 may include an image sensor device and a video processing module. In detail, the image sensor 161 may process a still image or a moving image obtained by the image sensor device (e.g., a CMOS or a CCD).

In addition, the image sensor 161 may process the still image or the moving image obtained through the image sensor device using an image recognition process (e.g., an OCR, etc.) and/or the video processing module to extract necessary information, and transmit the extracted information to the processor.

Such an image sensor 161 may be a camera assembly including at least one camera. The camera assembly may include a general camera for capturing a visible light band, and may further include a special camera, such as an infrared camera, a stereo camera, or the like.

In addition, depending on embodiments, the image sensor 161 as described above may be included in and operate within the central control terminal 100, or may be included in an external device (e.g., an external server, etc.) and interoperate with the communication processor 130 and/or the interface module 140 described above.

In an embodiment, the image sensor 161 may include a first camera for capturing a performance site and/or a second camera for capturing a setup site for the remote location lighting control service. In this regard, the second camera may be an AI camera.

That is, in an embodiment, the AI camera may be included in and operate within the central control terminal 100, or may exist separately from the central control terminal 100 but be electrically connected thereto and interoperate therewith.

The IMU 163 may sense at least one of a motion and an acceleration of the central control terminal 100. For example, the IMU 163 may be composed of a combination of various position sensors such as an accelerometer, a gyroscope, and a magnetometer.

In addition, the IMU 163 may recognize spatial information about the physical space around the central control terminal 100 by interworking with a location communication processor 130, such as a GPS module of the communication processor 130.

The audio sensor 165 may recognize a sound around the central control terminal 100.

In detail, the audio sensor 165 may include a sound collection microphone capable of sensing a sound output on-site.

In an embodiment, the audio sensor 165 may receive voice data required for the remote location lighting control service from a user.

Such an audio sensor 165 may be disposed in the central control terminal 100 in an embodiment, but in another embodiment, a plurality of sound collection microphones may exist independently of the central control terminal 100 and may be arranged at various locations within the site.

The display system 170 may output various information related to the remote location lighting control service as a graphic image.

In an embodiment, the display system 170 may display various user interfaces for the remote location lighting control service.

Such a display may include at least one of a liquid crystal display (LCD), a thin-film transistor-liquid crystal display (TFT LCD), an organic light-emitting diode (OLED), a flexible display, a 3D display, or an e-ink display.

The above-described components may be disposed within the housing of such a central control terminal 100, and the user interface may include a touch sensor 173 on a display 171 configured to receive a user touch input.

In detail, the display system 170 may include the display 171 for outputting an image and a touch sensor 173 for sensing a user touch input.

For example, the display 171 may be implemented as a touch screen by forming a mutual layer structure with the touch sensor 173 or being integrally formed therewith. Such a touch screen may function as a user input unit that provides an interface between the central control terminal 100 and the user, and may also provide an output interface between the central control terminal 100 and the user.

The central control terminal 100, including the above-described components, may store at least one captured video, pick-up information, lighting pattern information, and/or standard data in the memory 110, depending on the embodiments.

In an embodiment, the central control terminal 100 may transmit a control signal to lighting devices located on-site by including a module having a predetermined repeater function therein or interworking with a plurality of repeaters installed throughout the site, thereby transmitting and receiving the control signal to and from the plurality of lighting devices.

In an embodiment, the central control terminal 100 may obtain, in advance, information on shapes and/or lighting patterns (colors, effects, etc.) of lighting devices 300 to be recognized for each performance.

In addition, in an embodiment, the central control terminal 100 may pre-train a predetermined artificial intelligence model based on the information obtained in advance and shapes and/or lighting patterns (color, effects, etc.) of the lighting devices 300 actually captured using the AI camera.

In addition, in an embodiment, the central control terminal 100 may pre-train the model on a first lighting pattern for a first lighting device that is to be frequently picked up.

In one example, depending on embodiments, the central control terminal 100 may further perform at least some of the functional operations performed by the service providing server 200 to be described later.

### Service providing server 200

In one example, the service providing server 200, according to an embodiment of the present disclosure, may perform a series of processes for providing the remote location lighting control service.

In detail, in an embodiment, the service providing server 200 may provide the remote location lighting control service by exchanging, with an external device, data necessary for operating a remote location lighting control service process in the external device such as the central control terminal 100.

More specifically, in an embodiment, the service providing server 200 may provide an environment in which the application 111 may operate in the external device (in an embodiment, the mobile-type computing device 100-1 and/or the desktop-type computing device 100-2).

To this end, the service providing server 200 may include an application program, data, and/or instructions for operating the application 111, and may transmit and receive various data based thereon to and from the external device.

In addition, in an embodiment, the service providing server 200 may perform various deep learning for the remote location lighting control service by interworking with a deep learning neural network.

In this regard, the deep learning neural network, according to an embodiment may include a convolutional neural network (CNN), a region with CNN features (R-CNN), a fast R-CNN, a faster R-CNN, a mask R-CNN, and the like, and may include any deep learning neural network including an algorithm capable of implementing embodiments to be described below. In the embodiments of the present disclosure, such a deep learning neural network itself is not limited or restricted.

In this regard, depending on the embodiment, the deep learning neural network may perform deep learning for the remote location lighting control service by being directly implemented in the service providing server 200 or operating as a separate device from the service providing server 200.

Further, in an embodiment, the service providing server 200 may store at least one machine learning model.

For example, the service providing server 200 may store various machine learning models, such as a plurality of neural networks (e.g., deep neural networks) that implement a remote location lighting control service providing method based on structured or quantitative data, or other types of machine learning models including a non-linear model and/or a linear model, and may be configured as a combination thereof.

For example, the machine learning models may store a language model and/or a deep learning model pre-trained using linear regression, a decision tree, a random forest, and gradient boosting. Further, the neural networks may include at least one of a feed-forward neural network, a recurrent neural network (e.g., long and short-term memory recurrent neural networks), a convolutional neural network, and/or other types of neural networks.

In order to train such a machine learning model, the service providing server 200 may further include a model trainer in an embodiment.

For example, such a model trainer may perform updates on one or more parameters of a machine learning model for the remote location lighting control service based on a defined loss function in a backpropagation manner.

In some implementations, performing backpropagation of errors may include performing truncated backpropagation through time. The model trainer may implement a number of generalization techniques (e.g., a weight reduction, a drop-out, and/or a knowledge distillation) to improve the generalization capability of the trained machine learning model.

Further, the model trainer may train the machine learning model based on a series of training data. In this regard, the training data may include data in different forms, such as audio samples and/or text.

Further, depending on embodiments, the service providing server 200 may store a model to be used in each process and a prompt template that is a basis of input to the model, in order to perform at least some of the processes performed for implementing the remote location lighting control service providing method through a large language model (LLM).

In an embodiment, the central control terminal 100 may receive at least one machine learning model from the service providing server 200 through a network, then store the received machine learning model in the memory 110, and then execute the stored machine learning model by the processor assembly 120 to implement the remote location lighting control service providing method or the like.

In another embodiment, the central control terminal 100 may perform operations through at least one machine learning model by interworking with the service providing server 200, and may provide the remote location lighting control service to a user (in an embodiment, a user using the central control terminal 100) in a manner of exchanging data related to the performed operations with an external entity.

For example, the central control terminal 100 may perform the remote location lighting control service in such a manner that the service providing server 200 provides an output for a user input using the machine learning model through the web.

In addition, an artificial intelligence model may be implemented in such a manner that at least some of the machine learning models are executed in the central control terminal 100, and the rest are executed in the service providing server 200.

Hereinafter, the description will be made based on an embodiment in which the deep learning neural network and/or the machine learning model are directly implemented and executed in the service providing server 200.

In addition, in an embodiment, the service providing server 200 may read a predetermined deep learning neural network operating program, which is established to perform deep learning, from the memory, and perform deep learning as described below according to the read predetermined deep learning neural network system.

In detail, in an embodiment, the service providing server 200 may further include a data store computing system (hereinafter, referred to as a data store) that is storage for continuously storing and managing raw data that is a basis of the remote location lighting control service.

Such a data store may include various types of data storage, ranging from a file system to cloud storage. For example, the data store may include at least one database among: a relational database that uses a structured query language (SQL) to define and manipulate data; an NoSQL database that is designed for flexibility and scalability to process unstructured and semi-structured data; a data warehouse that is optimized for querying and analysis by centralizing large-scale data from multiple sources; a data warehouse that stores large amounts of raw data in basic format, including structured data, semi-structured data, and unstructured data; and a local storage device or network attached storage (NAS) that stores data in a file in a format generally accessible by a computer operating system.

In addition, in an embodiment, the service providing server 200 may store and manage various application programs, instructions, and/or data for implementing the remote location lighting control service.

In an embodiment, the service providing server 200 may store and manage a live video, a captured video, pick-up information, lighting pattern information, standard data, and/or a lighting pattern management interface.

However, functional operations that may be performed by the service providing server 200 in the embodiment of the present disclosure may not be limited to the above-described operations, and other functional operations may be further performed.

In one example, referring to FIG. 1, in an embodiment, the service providing server 200 as described above may be implemented as a predetermined computing device including at least one processor module 210 for data processing, at least one communication module 220 for data exchange with an external device, and at least one memory module 230 for storing various application programs, data, and/or instructions for providing the remote location lighting control service.

In this regard, the memory module 230 may store one or more of an operating system (OS), various application programs, data, and instructions for providing the remote location lighting control service.

In addition, the memory module 230 may include a program area and a data area.

In this regard, the program area, according to an embodiment, may be positioned between and associated with an operating system (OS) for booting a server and functional elements, and the data area may store data generated according to the use of the server.

In an embodiment, such a memory module 230 may be various storage devices such as a ROM, a RAM, an EPROM, a flash drive, a hard drive, and the like, or may be web storage that performs a storage function of the memory module 230 on the Internet.

In addition, the memory module 230 may be a recording medium in a form detachable from the server.

In one example, the processor module 210 may control overall operation of each unit described above in order to implement the remote location lighting control service.

Such a processor module 210 may be a system-on-chip (SOC) suitable for a server including a central processing unit (CPU) and/or a graphics processing unit (GPU), may execute the operating system (OS) and/or the application program stored in the memory module 230, and may control each component mounted on the server.

In addition, the processor module 210 may be in communication with each component internally via a system bus, and may include one or more predetermined bus structures, including a local bus.

In addition, the processor module 210 may be implemented using at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and an electrical unit for performing other functions.

Although the description has been made that the service providing server 200 according to an embodiment of the present disclosure performs the functional operations as described above, depending on embodiments, at least some of the functional operations performed by the service providing server 200 may be performed by an external device (e.g., the central control terminal 100, etc.), or at least some of the functional operations performed by the external device may be further performed by the service providing server 200. Therefore, various embodiments are possible.

In an embodiment, the service providing server 200 may obtain a live video in real time from the central control terminal 100 and/or a separate device for capturing a performance and stream the same in order to serve as an administrator for managing the entire remote location control system.

In detail, in an embodiment, when the AI camera is capturing images or video, the service providing server 200 may sequentially accumulate and temporarily store picked-up lighting pattern information at preset intervals.

In addition, in an embodiment, the service providing server 200 may determine whether the accumulated lighting pattern information was actually implemented by using specific time points as a start point and/or a stop point.

In addition, in an embodiment, the service providing server 200 may correct errors in the accumulated lighting pattern information by inspecting the picked-up lighting pattern information. For example, errors in the lighting pattern information may include a case in which an extracted lighting color is different from an actual lighting color on-site, a case in which an effect is incorrectly set, and the like.

In detail, inspection of the picked-up lighting pattern information is performed based on an artificial intelligence model pre-trained on a rendering color code for each type of lighting device. Therefore, the service providing server 200, according to an embodiment, may easily detect a case in which a color not used by the corresponding lighting device is extracted.

### Lighting device 300

In an embodiment of the present disclosure, the lighting device 300 may be a predetermined device that emits light in response to a control signal including setting values for brightness, color, saturation, effects, and the like received from a terminal located on-site and/or at a remote location (in an embodiment, the central control terminal 100 and/or the repeater 400).

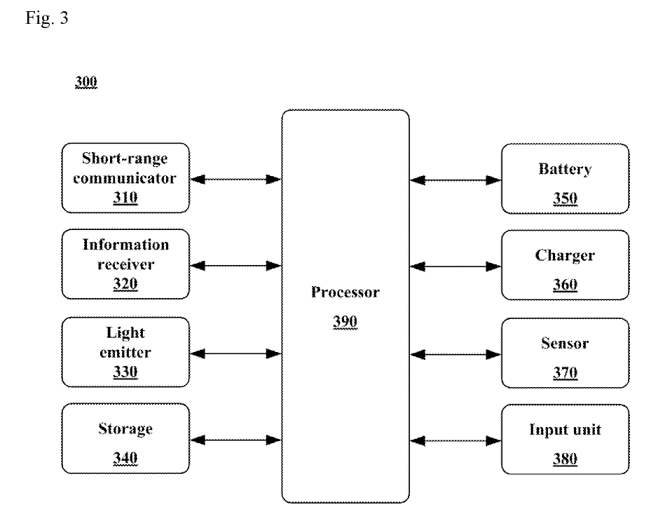

FIG. 3 is an internal block diagram of a lighting device according to an embodiment of the present disclosure.

Referring to FIG. 3, in an embodiment, the lighting device 300 may include a short-range communicator 310, an information receiver 320, a light emitter 330, storage 340, a battery 350, a charger 360, a sensor 370, an input unit 380, and a processor 390.

The short-range communicator 310 may include one or more devices for establishing communication with an external device. Such a short-range communicator 310 may establish communication through a wired and/or wireless network.

In an embodiment, the short-range communicator 310 may transmit and receive various data related to the remote location lighting control service to and from another terminal and/or an external server. In detail, in an embodiment, the short-range communicator 310 may receive a control signal including a predetermined control command.

The short-range communicator 310 may include a wireless communication module (e.g., at least one of infrared communication, NFC, IR transmitter/receiver, RF transmitter/receiver, Zigbee, Bluetooth, and WIFI modules).

For example, the lighting device 300 may receive the control signal at a predetermined period (e.g., 10ms) based on the short-range communicator 310.

The information receiver 320 may include a transmitter and a broadcast receiver that receives information transmitted from another device in a broadcasting manner. In detail, the broadcast receiver may receive radio waves transmitted from the transmitter through an antenna, and may obtain a control signal by filtering the control signal from the received radio waves.

In other words, the information receiver 320 may receive predetermined information (in an embodiment, the lighting pattern information) included in the control signal transmitted from the central control terminal 100 and/or the repeater 400.

The light emitter 330 may perform a function of emitting light in response to the control signal received based on the information receiver 320.

The light emitter 330 may include one or more light source elements, and examples of the light source may include a light-emitting diode (LED). In addition, the light emitter 330 may include LEDs of different colors, for example, at least one of a red LED, a green LED, a blue LED, and a white LED.

When light emitted from these LEDs is mixed, a wide range of colors may be produced. The mixed color may be determined based on a ratio of the intensities of the light beams emitted from the LEDs, and the intensity of a light beam emitted from each LED may be proportional to the driving current of each LED.

The plurality of LEDs included in the light emitter 330 may be arranged in a dot form, and a specific phrase (text), image, or video may be displayed as the plurality of LEDs are selectively turned on under the control of the processor 390 to be described later.

Although the LED has been described as the light source of the light emitter 330 as an example, the type of light source is not limited to the LED. According to another embodiment, an organic light-emitting diode (OLED) may be used as the light source.

The storage 340 may store one or more of various application programs, applications, data, and instructions for providing the remote location lighting control service environment.

In addition, the storage 340 may store data received or generated from other components of the remote location lighting control system. The storage 340 may be various storage devices, such as a ROM, an EPROM, a flash drive, a hard drive, and/or a USB drive, and may include a memory, a cache, a buffer, and the like.

In an embodiment, the storage 340 may pre-store information necessary for the lighting device 300 to emit light.

In an embodiment, such storage 340 may store at least one piece of visual production data and/or lighting pattern information defining a lighting form in which the lighting device 300 operates.

Further, in an embodiment, the storage 340 may store information necessary for performing the remote location lighting control service.

The battery 350 may receive external and/or internal power under the control of the processor 390 to supply power required for operation to each component of the lighting device 300.

Such a battery 350 may further include a DC/DC converter capable of converting the supplied power into a voltage level that may be used by mounted components of the lighting device 300.

In addition, the battery 350 includes at least one battery cell. Each battery cell is not particularly limited in its type as long as it is repeatedly chargeable and dischargeable, like a lithium ion cell.

The charger 360 may include wired and wireless charging modules for providing wired and wireless charging processes that supply the power required for the operation of the lighting device 300.

The sensor 370 may include at least one sensor among an IMU, an acceleration sensor, a gyro sensor, a distance sensor, a proximity sensor, a contact sensor, and an illuminance sensor.

In detail, the IMU included in the sensor 370 may sense at least one of the motion and acceleration of the lighting device 300. For example, the IMU may be composed of a combination of various position sensors such as an accelerometer, a gyroscope, and a magnetometer.

The input unit 380 may sense an input (e.g., a gesture, a manipulation of a button, or other types of input) of a user (e.g., an audience member using the lighting device 300) related to the remote location lighting control service.

In detail, the input unit 380 may include a predetermined button and/or a touch sensor.

In addition, the input unit 380 may be connected to an external controller and receive a user input.

The processor 390 may perform a data processing function of controlling overall operation of the lighting device 300, such as power supply control, and a signal flow between internal components of the lighting device 300 and processing data. Such a processor 390 may include at least one processor.

Further, the processor 390 may be in communication with each component internally via a system bus, and may include one or more predetermined bus structures including a local bus.

In addition, the processor 390 may be implemented to include at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and an electrical unit for performing other functions.

In an embodiment, the processor 390 may control a lighting pattern of light output from the light emitter 330 by controlling the driving current of each LED of the light emitter 330.

Accordingly, in an embodiment, the processor 390 may control the lighting device 300 including the plurality of LEDs, and may form a predetermined phrase, image, video, or the like.

The lighting device 300, including the above-described components, may operate according to at least one piece of data stored in the storage 340 under the control of the processor 390.

In addition, in an embodiment, the lighting device 300 may emit light via the light emitter 330 in response to a control signal received from the central control terminal 100, a predetermined repeater, and/or a transmitter.

In this regard, the control signal may include lighting pattern information included in the control signal itself or command data for activating the lighting device 300 to emit light with the visual production data pre-stored therein.

In addition, in an embodiment, the lighting device 300 may sense the motion and acceleration of the lighting device 300 based on the sensor 370.

In addition, in an embodiment, the lighting device 300 may recognize a surrounding sound based on the sensor 370 and control the light emitter to emit light according to the recognized sound. For example, the louder the recognized sound, the brighter the light may be emitted.

In addition, in an embodiment, the lighting device 300 may transmit the data sensed by the sensor 370 and/or the input unit to another device (e.g., the central control terminal 100).

In addition, in an embodiment, the lighting device 300 may operate passively in response to a command signal (control signal) transmitted from an external entity. In another embodiment, the lighting device 300 may operate on its own based on the input unit 380 (e.g., the predetermined button).

The concept of operation may vary and may not be limited to any one form. For example, various types of operations, such as a lighting operation, a sound-generating operation, and a mechanical operation, may be performed depending on the types of the lighting device 300 (e.g., a cheering stick, a lighting device, a lighting stick, a wearable band, and/or a wearable device).

### Repeater 400

The repeater 400 according to an embodiment of the present disclosure may be a computing device that receives lighting pattern data from the remote location lighting control application 111 of the central control terminal 100 and/or the service providing server 200 providing the remote location lighting control service, and transmits a control signal including the received lighting pattern data to control a plurality of lighting devices located within a predetermined distance.

Specifically, in an embodiment, the repeater 400 may be in communication with the central control terminal 100 and/or the service providing server 200 through a wired/wireless network to obtain at least one piece of lighting pattern data, and transmit a control signal for activating the lighting devices to emit light with the obtained lighting pattern data.

In an embodiment, the repeater 400 may be a device that is installed in advance at a predetermined remote location, which is a place where the performance is streamed, separate from the actual concert hall, and transmits a predetermined control signal to at least one lighting device sensed within a preset range.

In an embodiment, the repeater 400 may include a repeater terminal and/or an antenna.

The repeater terminal and the antenna may be in a 1:1 and/or 1:n relationship. In this regard, the antenna may be a directional antenna.

The repeater terminal may be installed in an indoor space, and the antenna may be installed in an outdoor space. For example, the repeater terminal may be installed on a wall, a ceiling, or the like of an indoor space, and the antenna may be installed on an outer wall, a railing, or the like of a building in an outdoor space.

In addition, the repeater terminal may include an LCD display. In this regard, predetermined information downloaded for providing the remote location lighting control service may be displayed on the LCD display.

Such a repeater 400 may transmit a control signal without the need to individually detect the positions of the lighting devices once it is installed at a predetermined location, thereby easily controlling multiple lighting devices without pairing with individual devices.

In addition, in an embodiment, the repeater 400 may transmit a predetermined control signal to at least one lighting device sensed within a preset range according to setting information.

In an embodiment, the setting information may include a signal radius and/or a propagation direction. Such setting information may be preset by a remote location lighting control service administrator (hereinafter, referred to as an administrator).

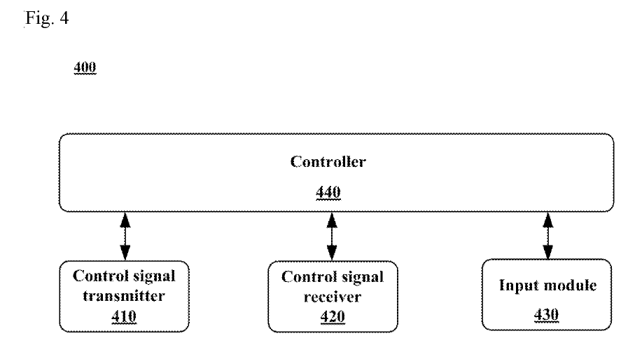

FIG. 4 is an internal block diagram of a repeater according to an embodiment of the present disclosure.

Referring to FIG. 4, the repeater 400 may include a control signal transmitter 410, a control signal receiver 420, an input module 430, and a controller 440. These components may be configured to be included within a housing of the repeater 400.

In detail, the control signal transmitter 410 may include one or more devices for establishing communication with the central control terminal 100 and/or the service providing server 200.

In addition, the control signal transmitter 410 may be in communication with another terminal in order to implement an environment for control signal communication.

In an embodiment, the control signal transmitter 410 may transmit and receive various data related to control signal communication to and from another terminal and/or external server.

Such a control signal transmitter 410 may wirelessly transmit and receive data to and from at least one of a base station, an external terminal, an arbitrary server, and an antenna on a mobile communication network established through a communication device capable of supporting technical standards or communication schemes for mobile communication (e.g., long term evolution (LTE), long term evolution-advanced (LTE-A), 5G new radio (NR), and WIFI), short-range communication schemes (e.g., NFC and RFID), and/or wireless communication schemes (RF and IR).

In addition, in an embodiment, the control signal transmitter 410 may transmit information based on a short-range communication scheme.

To this end, in an embodiment, the control signal transmitter 410 may include a wireless communication module (e.g., at least one of NFC, RF transmitter/receiver, Zigbee, Bluetooth, and Wi-Fi modules) for short-range communication.

In addition, in an embodiment, the control signal transmitter 410 may transmit a control signal received from the central control terminal 100 and/or the service providing server 200 to at least one other device (in an embodiment, a lighting device) in a one-to-many manner.

For example, the control signal transmitter 410 may transmit a control signal to at least one lighting device in a broadcasting manner (an all-to-all communication scheme of transmitting traffic to unspecified individuals without designating receivers).

In detail, the control signal transmitter 410 may transmit a control signal to lighting devices located in the vicinity using a preset broadcasting protocol. Lighting devices located in the vicinity and set to receive a broadcast signal of the preset broadcasting protocol may receive the transmitted control signal, and may operate in response to the received control signal.

In this regard, the preset broadcasting protocol may refer to a frequency band, a control signal encoding/decoding scheme, and the like. Such a control signal transmitter 410 may include a broadcast transmitter. Further, the broadcast transmitter may include an exciter composed of an oscillator and a modulator, and modulate the control signal received from the terminal 100 into radio waves in a predetermined frequency band according to the preset broadcasting protocol to transmit an RF signal through an antenna.

The use of the broadcasting scheme allows the control signal transmitter 410 to overcome problems such as low transmission speed, short transmission distance, small data transmission capacity, excessive power consumption, and the like, which are disadvantages of Bluetooth (BLE) technology. Further, the use of the broadcasting scheme facilitates control of a plurality of lighting devices, saves time required for pairing, which users have to perform separately for the lighting device control signal repeater 400 and each lighting device, and increases the promptness of data transmission.

In addition, in an embodiment, the control signal transmitter 410 may continuously transmit (e.g., infinitely loop) a control signal for triggering predetermined visual production data when a specific event and/or trigger is obtained.

In one example, the control signal receiver 420 may receive a control signal from another terminal, including the terminal 100, and/or a server.

Like the control signal transmitter 410, the control signal receiver 420 may include one or more devices for establishing communication with the terminal 100. Because the details are the same as above, the above description will be applied, and redundant descriptions will be omitted.

The input module 430 may sense a user input (e.g., a gesture, a voice command, a manipulation of a button, or other types of input) related to the remote location lighting control service.

To this end, the input module 430 may include a predetermined button, a controller, a touch sensor, and/or an image sensor that receives a user motion input.

In addition, the input module 430 may be connected to an external controller via an interface to receive user input.

In addition, the input module 430 may receive a user input (e.g., a touch input, a mouse input, a keyboard input, a gesture input, a motion input using a guide tool, etc.).

For example, the input module 430 of the repeater 400 may be connected to at least one device, such as a numeric keypad and an IR remote controller, through various communication protocols in a wired and/or wireless manner, and obtain a user input.

In this regard, in order to obtain a user input through a wired connection, the repeater 400 may include the interface (e.g., a USB connection port).

That is, the types of input provided to the input module 430 of the repeater 400 may include a direct manipulation input, a wired input, and/or a wireless input.

For example, the input may be performed based on a series of wired/wireless input devices (e.g., a keyboard, a numeric keypad, a mouse, a remote controller, etc.) connected to the USB connection port of the repeater 400.

In this regard, in the case of wired input, remote control is possible within the length of the cable. In the case of wireless input, remote control may be performed based on wireless technologies such as IR, RF, NFC, and Bluetooth, and/or by using a remote controller operatively coupled to the repeater 400. In this regard, no obstacle should be present in front of the repeater 400 and/or an IR sensor of the remote controller.

In addition, in an embodiment, the repeater 400 may further include an output system (e.g., a display, etc.) for displaying predetermined information according to the remote location lighting control service.

The controller 440 may include at least one processor capable of executing instructions for transmitting and receiving at least one control signal in order to perform various tasks for generating the remote location lighting control service environment.

In addition, in an embodiment, the repeater 400 may include at least one position sensor (e.g., a GPS sensor). Accordingly, the controller 440 may provide position information of the repeater obtained by the position sensor to the terminal 100 and/or the service providing server 200 linked thereto.

In addition, in an embodiment, the repeater 400 may include at least one image sensor (e.g., a camera). Accordingly, the controller 440 may provide an image and/or a video of a physical space around the repeater 400 to the central control terminal 100 and/or the service providing server 200 linked thereto.

In addition, in an embodiment, the repeater 400 may include at least one illuminance sensor. Accordingly, the controller 440 may periodically measure the brightness of a remote location through the illuminance sensor and provide the measured value to the central control terminal 100 and/or the service providing server 200.

In an embodiment, the controller 440 may control the overall operation of the components of the repeater 400 in order to provide the remote location lighting control service. Regarding the implementation of the controller 440, the description provided above for the processor assembly 120 of the central control terminal 100 will be applied.

### Method for controlling plurality of lighting devices using AI camera

Hereinafter, a method for implementing a remote location lighting control service for controlling a plurality of lighting devices using an AI camera by a remote location lighting control system (hereinafter, referred to as a computing system 1000) or at least one component included in the system according to an embodiment of the present disclosure will be described in detail.

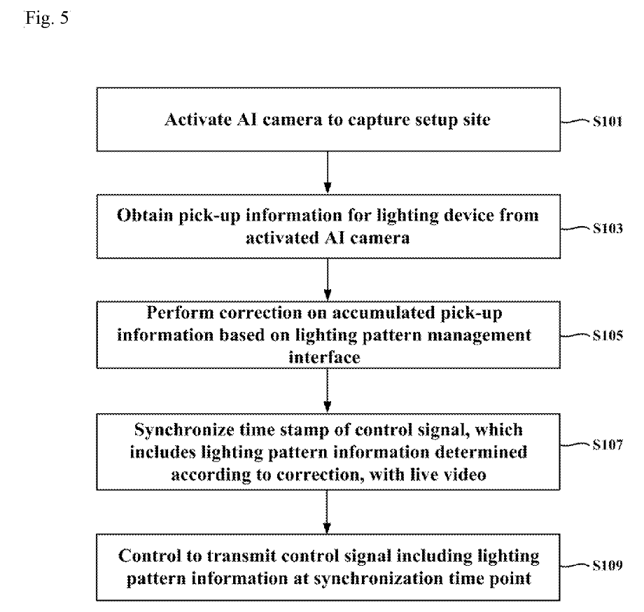

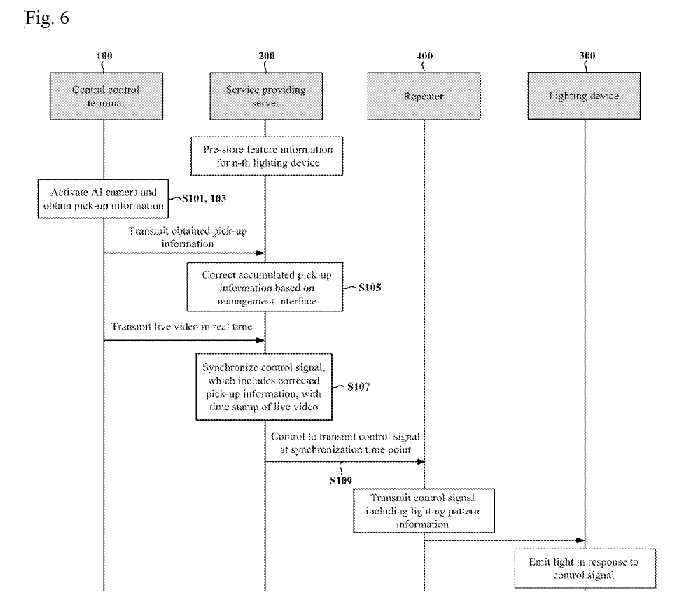

FIGS. 5 and 6 are flowcharts for illustrating a method for providing a remote location lighting control service using an AI camera according to an embodiment of the present disclosure. FIG. 5 is a flowchart centered on the service providing server 200, and FIG. 6 is a flowchart divided for each device constituting the remote location lighting control system.

Referring to FIGS. 5 and 6, in an embodiment, the computing system 1000 may activate the AI camera to capture a setup site (S101).

The AI camera is a camera that analyzes a captured image and/or video based on a predetermined artificial intelligence model/algorithm in real time.

In an embodiment, such an AI camera may be a camera that captures the plurality of lighting devices 300 arranged on-site for the remote location lighting control service and analyzes the captured image and/or video in real time based on a predetermined image analysis artificial intelligence model/algorithm to collect and generate data necessary for the remote location lighting control.

To this end, in an embodiment, an administrator may set up at least two lighting devices 300 on-site so as to pick up a predetermined lighting pattern from the captured image and/or video.

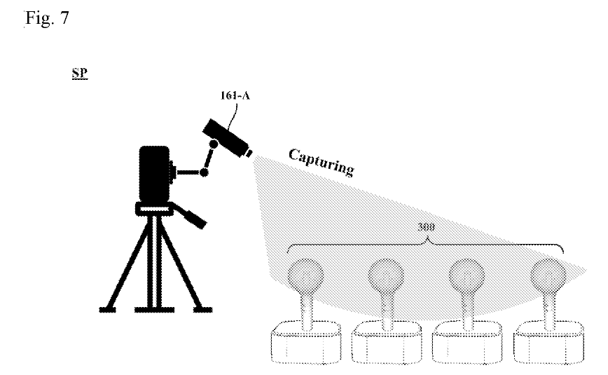

FIG. 7 is an example of a diagram schematically illustrating a setup site according to an embodiment of the present disclosure.

Referring to FIG. 7, in an embodiment, a setup site SP may be composed of a plurality of lighting devices 300, respectively paired with different seats and gathered closely enough to fit within a single frame, and an AI camera 161-A for capturing the devices.

In this regard, each lighting device 300 may be in a state of being mounted on a predetermined charging cradle so as to prevent the battery from being discharged. In addition, the AI camera 161-A may be in a state of having a fixed angle or continuously capturing the lighting devices 300 by aiming them as targets.

In addition, the different seats may refer to seats respectively assigned to major zones with distinct lighting timings during dynamic visual production, and thus, located in different areas. This is to allow an administrator to easily visually confirm that a time lag occurs in the lighting of the lighting devices 300 during a predetermined dynamic visual production.

In an embodiment, the computing system 1000 may activate the AI camera 161-A so as to capture the setup site based on a user input for the AI camera 161-A.

To this end, a user (specifically, an on-site operator) may activate the AI camera 161-A using a predetermined button provided on the application 111 of the central control terminal 100 and/or the AI camera 161-A, thereby starting capturing the lighting devices 300 at the setup site SP.

For example, the on-site operator may activate the AI camera 161-A by pressing a "send" button on the remote location lighting control application 111 or pressing a "record" button provided on the AI camera 161-A.

For reference, the on-site operator may be deployed only at the performance site and not at the remote location. In addition, the activation time point of the AI camera 161-A does not need to coincide with the performance start time point, and may be a predetermined time point before and after the performance.

In addition, in an embodiment, the computing system 1000 may obtain pick-up information for a lighting device from the activated AI camera 161-A (S103).

In this regard, the pick-up information may refer to lighting pattern information of the lighting device 300 extracted (i.e., picked up) from an image and/or a video (hereinafter, referred to as a captured video) captured by the AI camera 161-A.

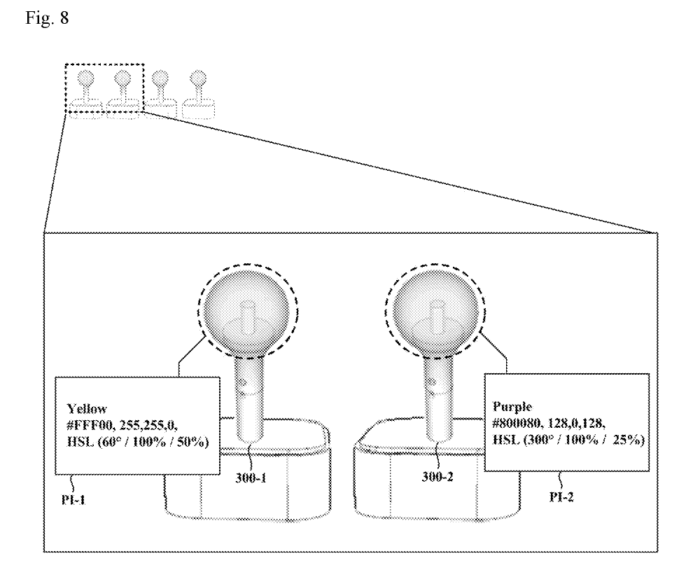

FIG. 8 is an example of a diagram for illustrating pick-up information according to an embodiment of the present disclosure.

Referring to FIG. 8, in an embodiment, the computing system 1000 may obtain pick-up information PI, including the lighting pattern information for at least one lighting device 300. In detail, first pick-up information PI-1 may be obtained for a first lighting device 300-1 and second pick-up information PI-2 may be obtained for a second lighting device 300-2.

The lighting pattern information according to an embodiment may refer to information defining a lighting form in which the lighting device 300 operates according to components including a lighting mode (e.g., an ON mode, an OFF mode, and/or a sound recognition mode), a lighting color, a lighting duration, a lighting brightness, and/or a lighting effect.

In an embodiment, such lighting pattern information may include a color parameter, an HSL parameter, and/or an effect parameter.

The color parameter may be a parameter for rendering a lighting color through RGB, HEX, and CMYK values and/or channel values for each color.

The lighting color may be expressed by assigning serial numbers to colors through the calculation of preset channel values for each color. For example, when the difference between the channel values for each color is great, a color having high saturation may be expressed, and when the difference between the channel values for each color is small, a color having low saturation may be expressed.

As another example, the lighting color may be expressed by a preset color code (e.g., red, blue, purple, etc.) indicating a predetermined color. As another example, the lighting color may be expressed by a serial number assigned in advance for each predetermined color for convenience or security. In addition, when a unique color exists for each artist and/or team, the unique color may be automatically determined as the lighting color for a specific lighting device 300.

For convenience of description, in the example to be described later, the lighting color will be described as being expressed by an alphabetical preset color code.

The HSL parameter may be a parameter for indicating lighting attributes through hue, saturation, and lightness.

The HSL parameter indicating the lighting attributes may determine the lighting mode and/or the lighting brightness. For example, through hue and saturation, detailed attributes of the color parameter may be indicated, or the lighting mode may be determined and indicated (e.g., when saturation is 0%, the lighting mode may be determined to be an OFF mode).

Such an HSL parameter may indicate the lighting attributes in a format such as 60°, 100%, and 50%.

The effect parameter may be a parameter for indicating the lighting effect, which is a lighting form in which various lighting components are set to change within a predetermined duration and generate a dynamic visual effect.

The lighting effect may be expressed by an effect name (e.g., blink, gradation, fade in, and fade out) or a unique value referring to each effect.

For example, the lighting effects may include 1) a blink effect in which whether to emit light is set differently over time within a predetermined duration to quickly flicker the light emitter 330, 2) a gradation effect in which the color is set to change over time within a predetermined duration, resulting in a gradual transition of the lighting color, 3) a fade in/out effect in which the brightness is set to change over time and thus gradually decreases or increases, and the like.

In addition, the duration of the lighting effect (i.e., the lighting duration) may be determined based on the effect parameter.

In an embodiment, the computing system 1000 may obtain the pick-up information PI for the lighting device from the AI camera 161-A that performs real-time analysis based on a predetermined artificial intelligence model and/or algorithm (hereinafter, collectively referred to as an image analysis model).

In this regard, the AI camera 161-A may simultaneously extract and generate the pick-up information PI for each of the plurality of lighting devices 300 included in the captured video.

In detail, the AI camera 161-A, according to an embodiment, may calculate an average RGB value and/or HSL value of pixels within a region of interest (ROI). In addition, the color parameter and/or the HSL parameter may be detected by determining the name of the color having the greatest similarity with the color defined by a user and a system. In addition, the effect parameter may be detected by analyzing a brightness variation pattern and a color change cycle between consecutive frames.

In other words, in an embodiment, the computing system 1000 may obtain the lighting pattern information, including the color parameter, the HSL parameter, and/or the effect parameter of each lighting device 300 captured by the AI camera 161-A as the pick-up information PI.

By obtaining the pick-up information PI, in an embodiment, the AI camera 161-A may also obtain the shape of the lighting devices 300 and a rendering color code (which is based on the color parameter and/or the HSL parameter) of the corresponding lighting devices.

In this regard, in an embodiment, the computing system 1000 may pre-train the AI camera 161-A (i.e., the image analysis model) based on the shape of the lighting devices and the rendering color code for each lighting device shape (collectively referred to as feature information) sensed based on the pick-up information PI.

In an embodiment, the reason for pre-training the image analysis model with the rendering color code for each lighting device shape is that, even with the same color parameter, the actually rendered lighting color may vary depending on different designs and hardware for each artist. Further, another purpose of the pre-training is to operate only lighting devices corresponding to the artist currently performing in a joint concert in which multiple artists perform at the same time.

For example, even when a first lighting device and a second lighting device, which are lighting devices for different artists, emit light with the same lighting color defined as "RED", there may be a predetermined difference in the colors actually rendered depending on the hardware and the configuration of the light emitter.

Accordingly, the AI camera 161-A, according to an embodiment, needs to be pre-trained on the specific color value (i.e., the rendering color code) used by each lighting device for each lighting device shape.

In detail, the AI camera 161-A according to an embodiment may specify the shape of a lighting device based on the image analysis model using a predetermined object recognition algorithm (e.g., an object recognition CNN).

In this regard, the image analysis model may map a device ID to each specified lighting device shape. This is because the artist a particular lighting device corresponds to may be identified based on the mapped device ID. Such a device ID may also be pre-stored in each of the lighting devices 300.

In addition, the AI camera 161-A, according to an embodiment, may extract a rendering color code based on a color parameter and/or an HSL parameter for the specified lighting device shape.

That is, in an embodiment, the AI camera 161-A may map the lighting device shape with the rendering color code and store mapping data, and train the image analysis model based on the stored mapping data.

In summary, in an embodiment, the computing system 1000 may obtain the pick-up information PI based on the AI camera 161-A pre-trained to use the captured video as input data and to provide the pick-up information PI, including the rendering color code for each lighting device shape as output data.

Additionally, in an embodiment, the central control terminal 100 may set, as a commercial tag, pick-up information PI that has been extracted at least a preset number of timesfor the first lighting device and may pre-train the model based on the commercial tag, thereby reducing an error rate during actual pick-up operation.

For example, when the signature color for the first lighting device is 'rose quartz' and a frequently used lighting effect therefor is 'breath', lighting pattern information including 'rose quartz'+ 'breath' may be set as the commercial tag for the first lighting device and used for the pre-training.

In addition, in an embodiment, the computing system 1000 may sequentially accumulate the obtained pick-up information PI in the service providing server 200 in chronological order. In this regard, in order to accumulate the pick-up information PI in chronological order, a time stamp recording a time at which the lighting (pattern) was sensed may be mapped to each pick-up information PI.

That is, the pick-up information PI, according to an embodiment, may include the time stamp, the device ID, the lighting pattern information (specifically, the lighting color, the lighting duration, the lighting brightness, and/or the lighting effect according to the rendering color code for each lighting device), and/or the commercial tag.

In addition, in an embodiment, the computing system 1000 may perform a correction on the accumulated pick-up information based on a lighting pattern management interface (S105).

In this regard, the lighting pattern management interface according to an embodiment may be an interface that visually displays, in real time, the pick-up information PI analyzed by the AI camera 161-A and transmitted to the service providing server 200.

In detail, in an embodiment, the lighting pattern management interface refers to an interface that supports an administrator to perform a correction during a time lag occurring between a pick-up time point at which the pick-up information PI is collected and a streaming time point of a live video played at a remote location.

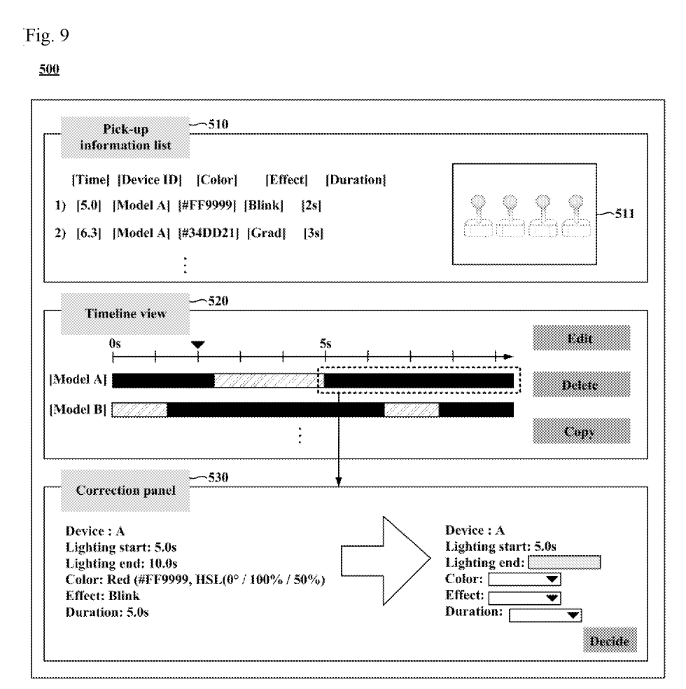

FIG. 9 is an example of a diagram for illustrating a lighting pattern management interface according to an embodiment of the present disclosure.

Referring to FIG. 9, in an embodiment, the computing system 1000 may perform a correction on the sequentially accumulated pick-up information PI in real time based on the lighting pattern management interface 5000.

The lighting pattern management interface 5000 may be composed of a pick-up information list 5100, a timeline view 5200, and/or a correction panel 5300.

The pick-up information list 5100 may be a list displaying a time stamp, a device ID, and lighting pattern information (specifically, a lighting color, a lighting duration, a lighting brightness, and/or a lighting effect).

In this regard, each pick-up information PI may be continuously accumulated in chronological order and displayed line by line. In addition, a predetermined check box and/or drop-down menu may be provided to set display conditions so that only pick-up information PI satisfying the conditions may be displayed.

In an embodiment, when an administrator clicks on specific pick-up information PI, details of the corresponding pick-up information PI may be displayed on the timeline view 5200 and/or the correction panel 5300.

In addition, a real-time screen 511, which shows an image and/or a video including a scene of the setup site captured in real time, may be displayed on the pick-up information list 5100 in order to support the administrator to intuitively check the actual lighting status of the lighting devices.

The timeline view 5200 may be a panel that visualizes which pick-up information PI was collected at a specific time point in time as a time axis graph.

In this regard, when a plurality of lighting device shapes are sensed, the computing system 1000 may separately generate a track (i.e., a horizontal time axis) for each distinct lighting device shape picked up.

That is, a number of tracks (i.e., horizontal time axes) corresponding to the number of lighting device shapes may be displayed on the timeline view 5200.

In addition, the timeline view 5200 may display blocks reflecting lighting colors from the pick-up information PI on the generated tracks, thereby providing an administrator with a visual representation of when and how the lighting pattern information of the lighting devices 300 change.

In this regard, a blackout block may be displayed in a blackout zone. In this regard, in an embodiment, the computing system 1000 may additionally provide a UI enabling a selection of a blackout effect processing scheme when an administrator clicks the blackout block.

For example, the blackout effect processing schemes may include a first scheme of setting the lighting mode to the OFF mode, a second scheme of maintaining the lighting color matched to the block immediately preceding the blackout block, and a third scheme of setting the lighting color to a color obtained by combining the lighting colors of two or more lighting devices that are not in a blackout state.

Further, the timeline view 5200 may display a playhead indicating a current playback position.

In an embodiment, when an administrator clicks a predetermined position on a track, pick-up information PI corresponding to that position may be displayed on the timeline view 5200 and/or the correction panel 5300.

The correction panel 5300 may display first pick-up information PI currently selected on the pick-up information list 5100 and/or the timeline view 5200.

In addition, the correction panel 5300 may provide a UI for correcting at least one of the components of the lighting pattern information (hereinafter, referred to as lighting pattern components) constituting the first pick-up information PI.

In an embodiment, an administrator may check an actual lighting pattern with the real-time screen 511 included in the pick-up information list 5100, and when it is determined that the pick-up information PI is different from the actual lighting pattern, may click the corresponding pick-up information PI and correct a predetermined lighting pattern component value.

As described above, in an embodiment, the computing system 1000 may perform a correction on the lighting pattern component value included in the accumulated at least one piece of pick-up information PI based on a predetermined input sensed by the lighting pattern management interface.

Accordingly, in an embodiment, the computing system 1000 may determine the corrected pick-up information PI as final lighting pattern information to be included in a control signal to be transmitted to the repeater.

In one example, an administrator performs a correction during the predetermined time lag occurring between the pick-up time point and the streaming time point based on the lighting pattern management interface. Because the time lag is relatively short, ranging from several seconds to several minutes depending on previous settings, a function for improving the accuracy and speed of the correction may be required.

Accordingly, in an embodiment, the computing system 1000 may provide an AI-based correction assistance function and a one-click correction function on the lighting pattern management interface so that an administrator may accurately and efficiently correct the pick-up information PI within a limited duration.

In order to provide such functions, in an embodiment, the AI camera 161-A may pre-store, as standard data, lighting pattern information used as a standard for each artist and/or performance based on pre-trained feature information.

In addition, in an embodiment, the AI camera 161-A may compare the lighting pattern information picked up during capturing with the standard data in real time and calculate a difference value therebetween.

In an embodiment, the computing system 1000 may obtain the calculated difference value from the AI camera 161-A, and when the difference value exceeds a set threshold, may highlight the corresponding pick-up information PI on the lighting pattern management interface 5000.

In this regard, the highlighting may appear in a visually distinguishable form, such as a separate icon or color highlight, on the pick-up information list 5100 and/or the timeline view 5200.

In an embodiment, an administrator may immediately check the details by clicking the highlighted pick-up information PI on the lighting pattern management interface 5000, and simultaneously, the lighting pattern management interface 5000 may automatically display an optimal correction value suggested by a predetermined artificial intelligence model AI.

In this regard, the optimal correction value may be provided by outputting and recommending, by the predetermined artificial intelligence model, a color value (i.e., a rendering color code) included in normalized feature information and standard data having the greatest similarity.

In addition, in an embodiment, the computing system 1000 may provide the one-click correction function for the highlighted pick-up information PI. This may be implemented in a form in which a one-click application button is provided on the lighting pattern management interface 5000 so that an administrator may immediately accept the correction value recommended by the AI.

In this regard, when an administrator clicks the one-click application button, in an embodiment, the computing system 1000 may update the accumulated pick-up information PI by updating the pick-up information PI including the recommended correction value in real time, convert the updated pick-up information PI into a control signal, and immediately switch to a transmission standby state.

As described above, in an embodiment, the computing system 1000 may combine the AI-based correction assistance function and the one-click correction function with the lighting pattern management interface, thereby enabling an administrator to accurately and quickly correct the pick-up information PI even within a short correction window (e.g., 15 seconds).

In addition, in an embodiment, the computing system 1000 may synchronize a time stamp of the control signal, which includes the lighting pattern information determined according to the correction, with the live video (S107).

In detail, in an embodiment, the computing system 1000 may synchronize the time stamp of the control signal including the lighting pattern information on which correction has been performed with the live video in consideration of an error between an actual site time point at which the pick-up information PI is obtained and a time point at which the live video is streamed at a remote location.

To this end, in an embodiment, the computing system 1000 may extract a time stamp (hereinafter, referred to as a local time stamp) indicating a time point at which the pick-up information PI is obtained at the actual site, which is included in each pick-up information PI.

In addition, in an embodiment, the computing system 1000 may receive, from the service providing server 200, a live video streamed to a remote location in real time and to which time stamps are mapped on a frame-by-frame basis.

Accordingly, similarly, in an embodiment, the computing system 1000 may extract the frame-by-frame time stamp (hereinafter, referred to as a streaming time stamp) mapped to the received live video.

In addition, in an embodiment, the computing system 1000 may calculate an offset for correcting a difference between the local time stamp and the streaming time stamp.

In an embodiment, the offset may refer to a time lag between a time point at which a control signal including a control command for causing lighting according to the lighting pattern information determined on the video frame is transmitted and an actual pick-up time point. For example, such an offset may be calculated including a network latency, a video processing delay, and other transmission delay factors.

In addition, in an embodiment, the computing system 1000 may apply the calculated offset to the local time stamp to calculate a synchronization time point exactly matching the streaming time stamp.

In addition, in an embodiment, the computing system 1000 may include the calculated synchronization time point in the control signal including lighting pattern information.

That is, in an embodiment, the computing system 1000 may control the repeater 400 and/or lighting devices 300 at a remote location to receive the control signal and implement a lighting-based visual production at precisely synchronized timing.

In addition, in an embodiment, the computing system 1000 may periodically update the streaming time stamp while the live video is being streamed, and re-measure the local time stamp corresponding thereto, thereby increasing the synchronization precision. To this end, network environment variations and latency changes may be monitored in real time during live streaming.

As such, in an embodiment, the computing system 1000 may precisely synchronize the time stamp of the control signal including the lighting pattern information with the time stamp at which the video frame is transmitted, thereby implementing the same lighting pattern as that at the actual performance site without a time error even at a remote location.

Accordingly, in an embodiment, the computing system 1000 may control the control signal including the lighting pattern information to be transmitted at the synchronization time point (S109).

In an embodiment, the computing system 1000 may perform a polling, which involves continuously exchanging responses with the service providing server 200 at a regular interval while transmitting the live video, thereby controlling the system components to continuously transmit the live video and the synchronized control signal.

In one example, in an embodiment, the computing system 1000 may perform a filtering based on the device ID matched for each lighting device, and configure settings so that, among the lighting devices located at a remote location, those having different device IDs do not respond to the transmitted control signal.

This may be a function additionally provided by the remote location lighting control service to operate only lighting devices corresponding to the artist currently performing at a joint concert in which multiple artists perform at the same time.

In an embodiment, the computing system 1000 may perform the device ID-based filtering so that, among the plurality of lighting devices 300, only specific lighting devices with a matching device ID react.

To this end, each of the plurality of lighting devices 300 may be given a unique device ID for each lighting device shape in advance and store the same in advance.

In addition, in an embodiment, the computing system 1000 may automatically map the device ID of each lighting device 300 when pre-training the AI camera 161-A on the hardware shape and/or rendering color code of each lighting device 300.

That is, in an embodiment, when generating the control signal including the pick-up information PI, the computing system 1000 may include a device ID for identifying a specific lighting device in the corresponding control signal.

When such a control signal is transmitted to a remote location, in an embodiment, the repeater 400 may perform a filtering based on the device ID included in the transmitted control signal, and transmit the signal only to lighting devices 300 whose device ID matches that in the control signal. Conversely, the signal may be blocked for lighting devices 300 with unmatching device IDs.

Alternatively, the repeater 400 may receive the control signal and transmit the control signal as it is, and only lighting devices 300 that pre-store the device ID included in the control signal among the lighting devices 300 may react and emit light.

In this case, in an embodiment, the lighting device 300 may perform a control signal filtering by comparing the pre-stored device ID with the device ID of the received control signal.

By performing such device ID-based filtering, in an embodiment, the computing system 1000 may implement precise lighting-based visual production without interference by allowing each device to selectively react only to designated signals, even in a performance environment in which the plurality of lighting devices 300 belonging to different artists and groups exist simultaneously.

As described above, after picking up the information on the lighting pattern manifested on-site through the AI camera in real time and converting the information into data, the computing system 1000 may perform an optimization process for identically reproducing the corresponding data at a plurality of remote locations having physical environments different from that of the on-site performance venue.

This is to overcome spatial constraints and implement the on-site dynamic visual production effects optimized for remote screening venue environments by automatically scaling and converting the on-site visual production data obtained by the AI camera according to the seat arrangement scale and shape at each remote location.

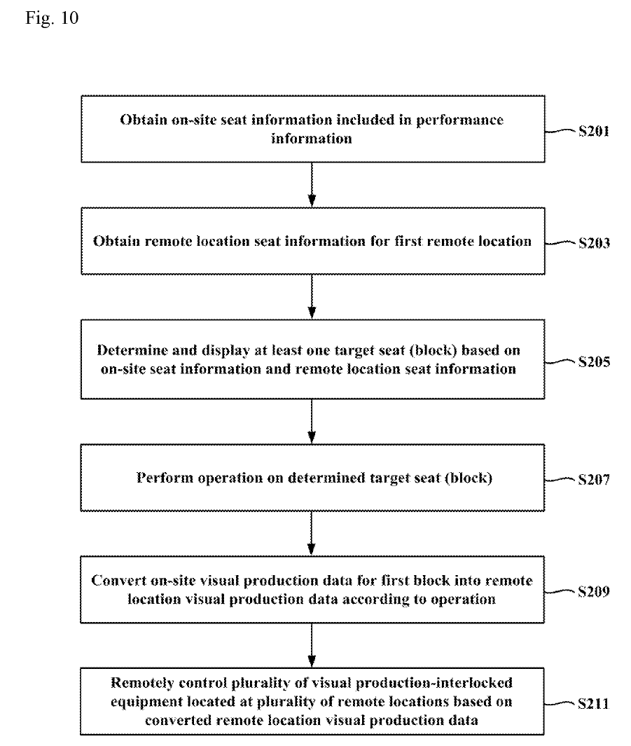

Hereinafter, a specific embodiment of converting the picked-up on-site visual production data into customized data for each remote location and integrally controlling repeaters located at a plurality of remote locations will be described in detail with reference to FIGS. 10 -15.

Method for converting on-site visual production data into remote location visual production data

FIG. 10 is a flowchart for illustrating a method for converting on-site visual production data into remote location visual production data according to an embodiment of the present disclosure.

Referring to FIG. 10, in an embodiment, the computing system 1000 may obtain on-site seat information included in performance information (S201).

In an embodiment, performances are classified into an actual performance performed in a concert hall or stadium where an artist actually performs (hereinafter, referred to as an on-site performance), and a performance provided by filming the on-site performance and playing the filmed performance at a remote location in real time (hereinafter, referred to as a remote location performance).

Accordingly, in an embodiment, on-site performance information and remote location performance information share a significant portion of the performance information, but there may exist predetermined portions that differ from each other depending on the physical characteristics of the location.

Specifically, the performance information may include basic performance information such as a performance name, artist information, and performance date and time, and/or technical information such as used equipment information and a control protocol for each equipment. The above-described pieces of information are commonly shared by the on-site performance information and the remote location performance information.

On the other hand, the performance information may include venue information, seat information, and visual production data that are generated differently between the on-site performance information and the remote location performance information. In this regard, in the case of the visual production data, visual production data of the on-site performance may be source data, and visual production data of the remote location performance may be data converted, compressed, and optimized to suit the remote environment.

In this regard, the seat information may include the number of seats, seat names, and/or a seat layout. The seat layout may be drawing data in a vector or bitmap format including a unique ID and a physical location (e.g., x, y, and z coordinates) within the venue of each seat.

In an embodiment, such seat layouts may be a reference for spatial analysis of the on-site performance or the remote location performance and/or mapping therebetween.

That is, in an embodiment, the computing system 1000 may extract and obtain seat information of the on-site performance (hereinafter, on-site seat information) included in the performance information.

In addition, in an embodiment, the computing system 1000 may obtain remote location seat information for a first remote location among at least one remote location (S203).

The on-site performance may be streamed at a plurality of remote locations. In an embodiment, the first remote location refers to a remote location determined by the administrator as a conversion target.

The remote location seat information is merely seat information for a 'remote location' and a basic structure thereof is the same as that of the on-site seat information, and thus a description thereof will be omitted.

In an embodiment, the title of the on-site seat information and/or the remote location seat information may be set as the venue name to facilitate identification.

In addition, in an embodiment, the computing system 1000 may determine and display at least one seat (or block) based on the on-site seat information and the remote location seat information (S205).

In detail, in an embodiment, the computing system 1000 may analyze the seat information and the visual production data for each of the on-site performance and the remote location performance, and display at least one seat or block on a visual production interface so that a user (in an embodiment, a director) may select seats to be set as a reference for conversion.

Hereinafter, a seat to be set as the reference for conversion will be referred to as a "target seat", a set of seats will be referred to as a "block", and a set of target seats will be referred to as a "target block".

In an embodiment, the block is a set of seats among audience seats (seats) where visual production using the lighting devices 300 is performed in the on-site performance, specifically those where visual production intended to be performed at a remote location is performed. Further, the block refers to seat(s) that are the reference for conversion.

In an embodiment, the seat or block may be determined according to 1) a manual designation method or 2) a remote location seat information-based recommendation method.

In 1) the manual designation method, a user (in an embodiment, a director) may manually designate a seat and/or a block to be converted suitably for a remote location performance among the visual production data and/or seat information for the on-site performance.

In this regard, in an embodiment, the computing system 1000 may display at least one seat or block by displaying a seat list composed of text and/or a seat layout composed of images based on the visual production interface.

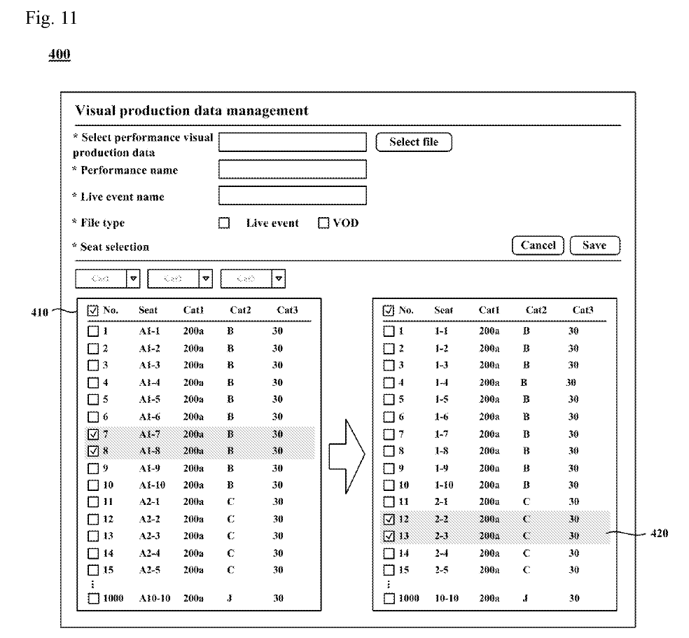

FIG. 11 is an example of a visual production interface in which a seat list is displayed according to an embodiment of the present disclosure.

Referring to FIG. 11, a user according to an embodiment may manually select at least one target seat 620 on a seat list 610 of a visual production interface 600.

To this end, in an embodiment, the computing system 1000 may parse the on-site seat information, convert individual seats included in the on-site performance venue into objects having attributes such as unique IDs, coordinate values, and designated sections, and list-up the individual seats to the seat list 610.

That is, the user may select the target seat 620 to be converted based on the on-site seat information displayed on the seat list 610 by clicking and/or dragging the same.

In this regard, in order to assist the user's selection, in an embodiment, the computing system 1000 may analyze the on-site visual production data in advance and automatically recommend at least one target seat 620 through an automatic process according to visual production complexity, visual production type, and/or visual production capacity.

In another embodiment, the visual production interface 600 may display an on-site seat layout, and accordingly, the application 111 may determine a seat where an input is sensed as the target seat.

Returning again, in 2) the remote location seat information-based recommendation method, the application 111 may automatically recommend a candidate block based on the visual production data and/or the seat data for each of the on-site performance and the remote location performance.

In an embodiment, the candidate block refers to a set of at least two seats determined to be suitable for conversion of visual production data because they have the highest similarity in shape with the seat layout of the remote screening venue among all seats of the on-site performance.

Such a candidate block may be extracted based only on shape matching, or may be extracted because a visual production pattern in section control performed in the on-site performance is applicable as it is. In the former case, the number of seats in the on-site performance venue and the remote location may not be the same, whereas in the latter case, the number of seats may be identical.

To this end, in an embodiment, the computing system 1000 may perform a candidate block filtering process.

In detail, the application 111 may analyze the shape of the remote location seat layout (e.g., the horizontal-to-vertical ratio of the block, the angle of each seat, the number of seats, the seat density, etc.) based on the remote location seat information.

In addition, as a result of the analysis, the application 111 may display an area where the shape similarity with the remote location seat information is equal to or greater than a preset ratio (e.g., 80%) as the candidate block on the visual production interface 600.

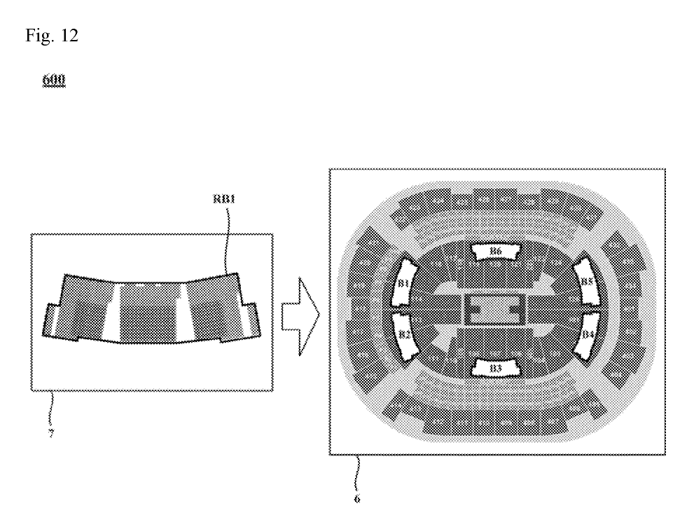

FIG. 12 is an example of a visual production interface in which candidate blocks are displayed according to an embodiment of the present disclosure.

Referring to FIG. 12, in an embodiment, the computing system 1000 may overlay a remote location seat layout 7 on an on-site seat layout 6 based on the visual production interface 600 to display at least one candidate block B1, B2, B3, B4, B5, and B6.

Accordingly, the user may determine a block to be converted among the at least one candidate block as the target block.

Hereinafter, it is assumed that a first candidate block B1 is determined, and a block on the on-site seat layout 10 is referred to as an "on-site block" and a block on the remote location seat layout 7 is referred to as a "remote location block".

In addition, the application 111 may list up and display information on a plurality of on-site seats and remote location seats included in the selected target block. Specifically, seats may be automatically extracted to the extent that the number of rows and seat numbers within those rows match between the on-site performance venue and the remote location.

In this regard, in an embodiment, the user may determine one of control methods between section control and/or total control.

In detail, section control refers to a control method that transplants a visual production pattern of the target block from the on-site performance to remote seats as it is. Total control refers to a method of identically applying visual production data of a specific seat from the on-site performance to all seats at the remote location.

When section control is determined, the application 111 may perform a 1:1 mapping between seat numbers of the on-site seat information and the remote location seat information. In addition, the mapped result may be displayed on the visual production interface 600.

When total control is determined, the application 111 may collectively apply visual production data of the target seat to the remote location seat information without the mapping.

In addition, in an embodiment, the computing system 1000 may perform an operation on the determined target seat (block) (S207).

In detail, in an embodiment, when the target block is determined based only on the shape matching, the computing system 1000 may perform a visual production shape scaling operation of scaling up or down the visual production data from the on-site seats to fit the scale of the remote location seats.

This is performed when a seat parameter (in an embodiment, the number of seats, rows, or columns) of the target block determined in the on-site performance does not match a seat parameter of the remote location seat information, in order to optimize the size of the visual production shape for the remote location while maximally preserving the visual pattern of the on-site visual production shape.

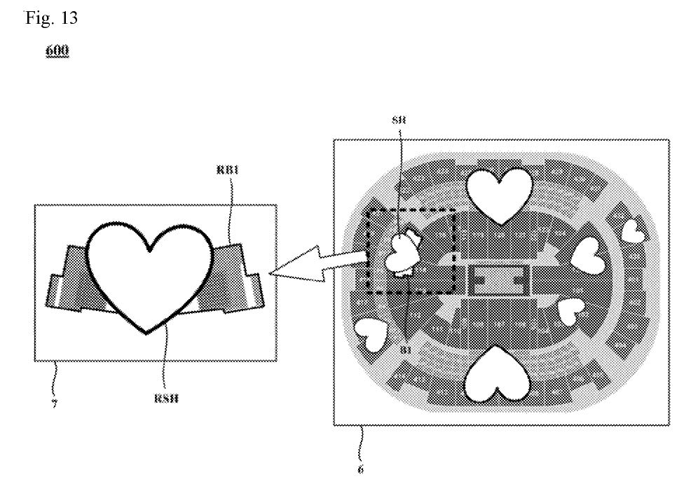

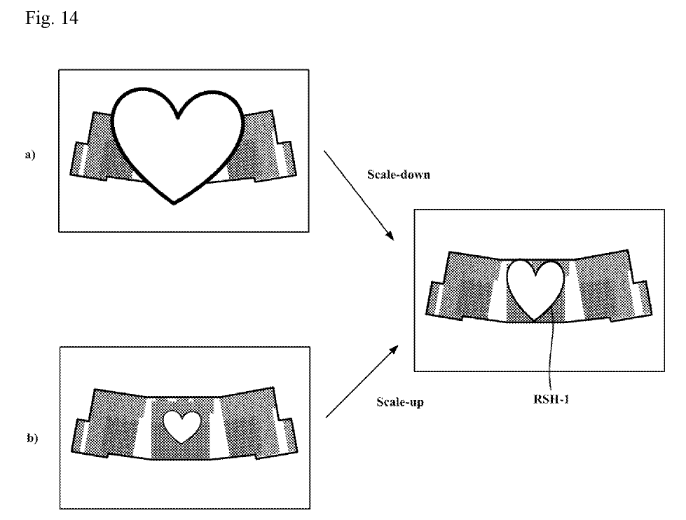

FIGS. 13 and 14 are examples of diagrams for illustrating visual production shape scaling according to an embodiment of the present disclosure. As an example, FIG. 13 illustrates a case in which the scale-down operation is performed.

Referring to FIGS. 13 and 14, on the visual production interface 600, an on-site block B1 and an on-site visual production shape SH manifested in the corresponding block are displayed on on-site seat information 10. Further, a remote location block RB1 and a remote location visual production shape RSH manifested in the corresponding block are displayed on remote location seat information 20.

In an embodiment, the computing system 1000 may perform the visual production shape scaling operation to convert the on-site visual production shape SH of the on-site block B1 into the remote location visual production shape RSH of the remote location block RB1.

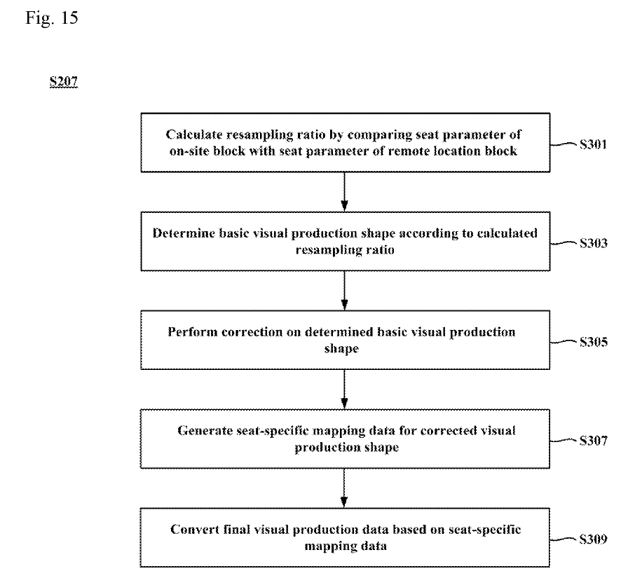

FIG. 15 is a flowchart illustrating a visual production shape scaling operation process according to an embodiment of the present disclosure.

Referring to FIG. 15, in an embodiment, the computing system 1000 may calculate a resampling ratio by comparing a seat parameter of the on-site block with a seat parameter of the remote location block (S301).

In this regard, different operations are performed depending on which value is greater between the seat parameter of the on-site block and the seat parameter of the remote location block.

First, when the seat parameter of the on-site block B1 has a greater value than the seat parameter of the remote location block RB1, a) the scale-down operation may be performed.

Specifically, in an embodiment, the computing system 1000 may calculate a resampling ratio for proportional data deletion based on a difference between the seat parameter of the on-site block B1 and the seat parameter of the remote location block RB1.

For example, when the on-site block B1 includes 20 row data and the remote location block RB1 includes 15 row data, the application 111 may extract 15 row data for the on-site block B1 by excluding 1 row data from sampling for every 4 row data in order to delete 5 row data.

Such an operation may be independently performed for each seat parameter.

Conversely, when the seat parameter of the on-site block B1 has a smaller value than the seat parameter of the remote location block RB1, b) the scale-up operation may be performed.

Specifically, in an embodiment, the computing system 1000 may calculate a resampling ratio for proportional data duplication based on the difference between the seat parameter of the on-site block B1 and the seat parameter of the remote location block RB1.

For example, when the on-site block B1 includes 20 row data and the remote location block RB1 includes 25 row data, the application 111 may generate 25 row data for the on-site block B1 by inserting 1 row data into the sampling for every 4 row data in order to add 5 row data.

In addition, in an embodiment, the computing system 1000 may determine a basic visual production shape according to the calculated resampling ratio (S303).

When the scale-down operation is performed, the application 111 may generate a reduced dataset suitable for the seat parameter of the remote location block according to the deletion ratio.

When the scale-up operation is performed, the application 111 may generate an expanded dataset suitable for the seat parameter of the remote location block according to the addition ratio.

In this regard, the reduced or expanded dataset refers to the basic visual production shape.

While such a basic visual production shape has a size optimized for the remote location block, the continuity of visual production data values may be somewhat lowered, which may lead to unnatural visual production.

Accordingly, in order to improve the visual production quality, the application 111 may perform correction on the determined basic visual production shape (S305).

In detail, in an embodiment, the computing system 1000 may perform correction based on mathematical interpolation with reference to visual production values of seats adjacent to the seat position with deleted or added data.

In this regard, the visual production values may refer to elements that determine lighting attributes of the lighting devices 300, such as lighting pattern setting values including lighting color, lighting brightness, and/or lighting effects.

Regarding the seat position with the deleted data, the application 111 may estimate a visual production value that the deleted row or column would have from the data of adjacent seats, and reflect the estimation in the production value correction of the adjacent seat data to mitigate sudden changes.

Conversely, regarding the seat position with the added data, the application 111 may replace visual production values of the simply duplicated row or column with an average or weighted average value of data values of seats located on both sides to implement a smooth transition.

Accordingly, the basic visual production shape may be converted into the corrected visual production shape RSH optimized for the remote location seat layout 7.

In addition, in an embodiment, the computing system 1000 may generate seat-specific mapping data for the corrected visual production shape (S307).

To this end, in an embodiment, the computing system 1000 may map a seat within the on-site block to a seat within the remote location block.

The seat-specific mapping data may include source information and value modification information.

The source information may be a unique ID of the seat within the on-site block that affects the visual production value of the corresponding remote location seat.

The value modification information may include whether the visual production value of the corresponding remote location seat is uniform or has been modified by an operation, along with information on an algorithm or weight used for the modification.

Finally, in an embodiment, the computing system 1000 may convert final visual production data based on the seat-specific mapping data (S309).

This is the same step as step S209 in the flowchart in FIG. 10. That is, returning to the previous topic, in an embodiment, the computing system 1000 may convert the on-site visual production data for the target block into the remote location visual production data according to the operation (S109).

In an embodiment, the computing system 1000 may generate the remote location visual production data according to the control method.

Specifically, in the case of section control, according to the mapping data between the seat within the on-site block and the seat within the remote location block, the remote location visual production data including visual production values corresponding to each remote seat may be generated so as to be aligned with the timeline of the scaled on-site visual production data.

For example, visual production data for 'Seat 1, Row 1, Section A, 3rd Floor' at the Sangam Stadium, where the on-site performance is performed, may be mapped and converted into visual production data for 'Seat 3, Row A' at the Yongsan IMAX, where the performance streaming is performed.

On the other hand, in the case of total control (collective application), visual production data corresponding to the seat within the selected on-site block may be extracted and identically applied to all seats within the remote location block to generate the remote location visual production data.

In an embodiment, the application 111 may use on-site visual production data of at least one seat for control collectively applied to the seats within the remote location block. Specifically, as an example of total control (collective application), when the control is based on a portion of a complex section-based visual production, dark intervals are intentionally inserted for the continuity of visual production or the expressive effects may be collectively applied.

In this case, in an embodiment, the computing system 1000 may additionally perform an operation for automatically correcting the dark intervals to generate the final visual production data to be applied to all seats at the remote location.

In more detail, the application 111 may first detect a dark interval from the on-site visual production data and measure the duration of the corresponding interval. Thereafter, one of (1) a first visual production value immediately before the dark interval (e.g., a previous color value), (3) a second visual production value immediately after the dark interval (e.g., a next color value), or (2) an intermediate value (e.g., an interpolated color value) of the first and second visual production values may be determined as a visual production correction value.

In this regard, the selection of one of (1) to (3) may be made based on the passage of time within the duration of the dark interval.

For example, the application 111 may generate corrected visual production data by adding a color effect during the transition from the first visual production value to the second visual production value. Specifically, the application 111 may generate the corrected visual production data by applying a color transition to the first visual production value and replacing the dark interval with a visually smooth gradation effect that transitions into the second visual production value.

In more detail, the application 111 may detect a dark interval from the on-site visual production data, and detect the duration of the corresponding interval, the first visual production value immediately before the dark interval, and the second visual production value immediately after the dark interval.

Thereafter, the application 111 may perform a continuous color transition or gradation operation that naturally links the first visual production value to the second visual production value across the entire duration of the dark interval.

That is, the corrected visual production data may be generated to start with the first visual production value at a time point at which the dark interval starts, and to reach a color value immediately before reaching the second visual production value (an immediate subsequent color) at a time point at which the dark interval ends.

The visual production data with the dark interval corrected as such may be applied to at least one seat within the remote location block. This may prevent interruptions of visual production that may occur when using the section-based control data for the total control, and may provide a continuous and stable viewing experience even at remote environments.

The converted remote location visual production data may be configured in the form of a control signal packet including a time stamp. In this regard, the packet includes the visual production value of the remote location visual production data.

The remote location visual production data may be transmitted to the repeater 400 located at each remote location.

In addition, in an embodiment, the computing system 1000 may remotely control a plurality of repeaters located at a plurality of remote locations based on the converted remote location visual production data (S211).

To this end, the application 111 may generate data defining lighting of lighting devices 300 within a predetermined radius (i.e., lighting-based visual production synchronization data) to correspond to the remote location visual production data. In this regard, at least one of the artist name, performance name, performance date and time, and/or performance session number may be mapped to the lighting-based visual production synchronization data.

In addition, the application 111 may remotely control the repeater 400 located at each remote location to transmit a lighting control signal containing the generated lighting-based visual production synchronization data.

In this regard, the application 111 may preset and register a remote location to perform remote control and a video/control signal transmission time (i.e., a remote location performance streaming start time) for each remote location.

Accordingly, the repeater 400 may transmit the lighting-based visual production synchronization data to the plurality of lighting devices 300 according to the start time of a performance video played at a remote location.

Then, the lighting devices 300 located at each remote location may be activated to emit light according to the lighting-based visual production synchronization data.

The remote location visual production data, optimized and converted as such to match the physical characteristics of each remote location, is transmitted to the repeater 400 disposed at each location through the network to control the lighting devices 300 of the actual audience.

In this regard, an integrated control process of monitoring and controlling the status of each repeater 400 in real time from a central location is required in order to secure the stability of live services simultaneously conducted across a plurality of remote locations, without simply transmitting data.

Accordingly, the computing system 1000 may maximize the completeness of the live services by establishing a management environment that provides a comprehensive view of the screening status and equipment operational status at each remote location and enables immediate response to possible sync errors or equipment failures.

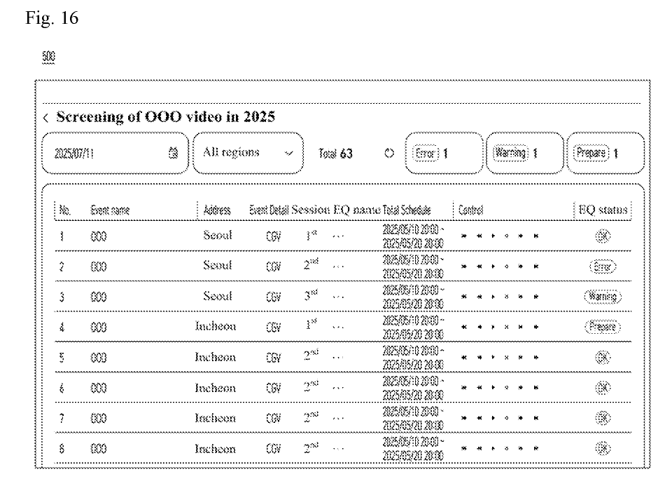

Hereinafter, a specific embodiment regarding efficient integrated management and remote control of such equipment at multiple remote locations will be described in detail with reference to FIGS. 16 - 20.

### Method for remotely controlling repeaters located at plurality of remote locations

In an embodiment, the computing system 1000 may provide an administrator interface for integrally managing the live services conducted across a plurality of remote locations.

In an embodiment, an administrator interface 500 provided by the application 111 may provide an integrated dashboard function for integrally managing a plurality of performance screenings (events) scheduled to be performed within a preset period or in progress, as well as monitoring a single performance provided as a live service.

In the following description, an event is defined as a streaming event of playing a performance video at different remote locations for the same performance. In addition, a live service refers to a service that provides such a streaming event in real time.

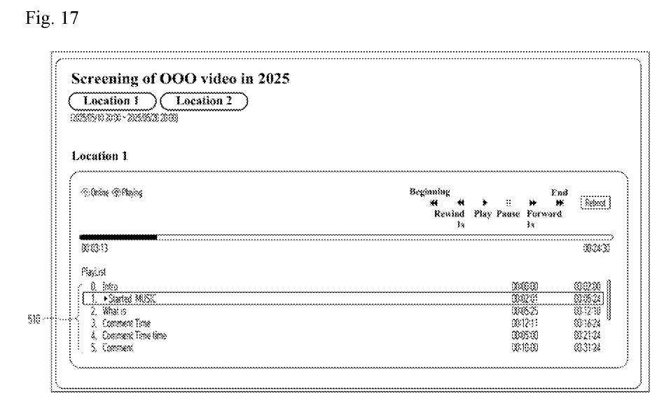

FIGS. 16 and 17 are examples of diagrams for illustrating an integrated dashboard function of an administrator interface according to an embodiment of the present disclosure.

Referring to FIG. 16, the administrator interface 500 may display a plurality of events for a first performance. In addition, detailed event information may be displayed for each event.

The detailed event information may include place name of remote location, screening session number, repeater model name, performance screening schedule, repeater status information, and the like.

When an event to be controlled is selected from among the plurality of displayed events, the administrator interface 500 may display a playlist-based performance timeline as shown in FIG. 17.

A performance timeline 510 represents a list of scenarios provided in order during the entire performance. In this regard, the scenarios may be, for example, a plurality of songs, and may include the progress time and/or event time during the performance.

Specifically, when an administrator presses a first scenario on the playlist, an adjustment bar may be provided to allow adjustments such as ‘n seconds backward’, ‘play’, ‘pause’, ‘n seconds forward’, and the like in the corresponding scenario. In addition, the administrator may force the playback of a second scenario during the playback of the first scenario to match the progress of the performance screening at the remote location.

That is, the administrator may monitor and remotely control each repeater by inputting adjustment commands for playback status information of the plurality of repeaters via the administrator interface 500.

In each scenario, playback time information of the corresponding scenario may be displayed together. When the administrator selects a specific scenario on the playlist, in an embodiment, the computing system 1000 may immediately jump the video transmission time point and/or the lighting-based visual production control signal transmission time point of the corresponding event to the start point of the corresponding scenario.

In addition, in an embodiment, the computing system 1000 may collectively control the video transmission time points and/or the lighting-based visual production control signal transmission time points of a plurality of events for the first performance displayed on the administrator interface 500.

The plurality of events for the first performance may be grouped into a single series and collectively controlled by the administrator.

For example, when the administrator inputs a collective control button, event series included in the same performance may be collectively controlled. To this end, the place, screening session number, and repeater of each remote location must be registered in advance.

In addition, in an embodiment, the computing system 1000 may provide a management function for the repeaters located at the plurality of remote locations via the administrator interface.

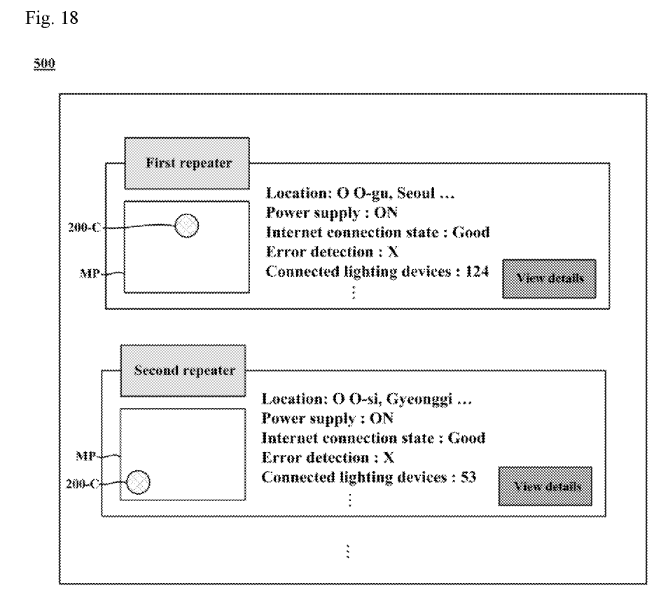

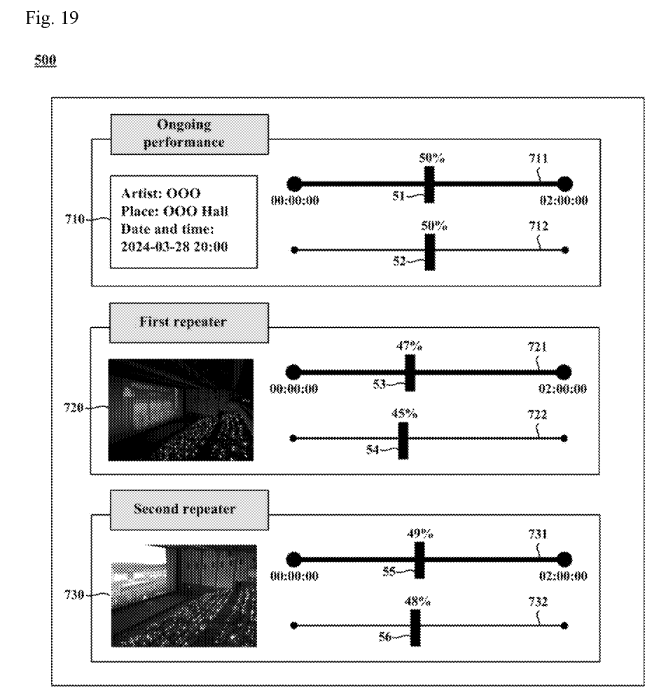

FIGS. 18 and 19 are examples of diagrams for illustrating a repeater management function of an administrator interface according to an embodiment of the present disclosure.

Referring to FIG. 18, in an embodiment, the computing system 1000 may display status information for the plurality of repeaters 400.

In this regard, the status information according to an embodiment may be information indicating whether a repeater 400 is in a state capable of operating normally in response to the lighting-based visual production control signal.

In an embodiment, the status information may include at least one of repeater unique identifier (ID), repeater power status, repeater location, repeater Internet connection status, repeater operational status, and/or the number of lighting devices connected to the repeater.

For example, the repeater power status may be displayed as one of ‘on’ and ‘off’ and/or ‘connected’ and ‘disconnected’. The repeater Internet connection status may be displayed as 'good', 'fair', 'slow', and the like, based on a preset Internet connection speed reference. The repeater operational status may be displayed as one of ‘connected’, ‘disconnected’, or ‘error’ depending on whether there is an error found in the corresponding repeater. In this regard, when the ‘error’ is displayed, the number of the corresponding repeater may be displayed together. The number of lighting devices connected to the repeater represents the number of lighting devices that are normally receiving control signals from the repeater, and may be displayed as a predetermined number.

Further, the status information may indicate the status of visual production data to be transmitted to the repeater as ‘upload’ and/or ‘ready’. In addition, the status of remote control may be displayed as ‘start’, ‘finish’, and the like.

In addition, in an embodiment, the repeater location included in the status information may be displayed as repeater location information MP. In an embodiment, the repeater location information MP may refer to content that schematically displays where the repeater 400 is disposed at the remote location.

For example, the application 111 may display a repeater location 200-C by obtaining location information of each repeater based on a GPS embedded in each repeater.

Further, referring to FIG. 19, in an embodiment, the computing system 1000 may display performance status information for the plurality of repeaters 400.

In this regard, the performance status information according to an embodiment may be information visually indicating the status of the performance at the on-site performance venue and the streaming progress at the remote location where the repeater 400 is located.

In addition, in an embodiment, the performance status information may include basic information, progress rate, control signal status information for a currently ongoing performance, and/or progress rate and control signal status information for a streaming video provided by each of the plurality of repeaters 400.

In detail, in an embodiment, the computing system 1000 may display, via the administrator interface 500, performance status information including basic information 710, performance progress 711, and performance venue control signal 712 for the currently ongoing performance.

In addition, in an embodiment, the computing system 1000 may display, via the administrator interface 500, performance status information including remote site information 720 and 730, streaming performance progress 721 and 731, and remote location control signals 722 and 732 for each repeater, for streaming performances in progress at the plurality of remote locations.

Although only a first repeater and a second repeater are shown in FIG. 19, in an embodiment, the computing system 1000 may display all of the plurality of repeaters connected to the server 200 via the administrator interface 500.

The basic information 710 is information on the currently ongoing performance obtained from the server 200, and may include at least one of performance artist, performance venue, and performance date and time.

The performance progress 711 may be information indicating the time point representing the current progress of the performance within the running time thereof. The corresponding time point may be indicated as a performance progress time point 51. For example, the performance progress time point 51 may be displayed in a time format (hours, minutes, and seconds), or as a progress percentage (%) of the total running time.

The performance venue control signal 712 may be information indicating the current time point at which a performance venue control signal transmitted from the performance venue is being transmitted within the running time thereof. The corresponding time point may be indicated as a performance venue control signal transmission time point 52.

In this regard, the performance progress time point 51 and the performance venue control signal transmission time point 52 may be identical. This is because there is no delay caused by the external transmission of video and control signals at the performance venue.

The streaming video progress 721 may be information indicating the current playback time point of the streaming performance within the running time thereof. The corresponding time point may be indicated as a streaming time point 53. Similarly, the streaming time point 53 may also be displayed in a time format and/or as a percentage.

In this regard, the performance progress time point 51 and the streaming time point 53 may be different from each other. This is because a delay may occur depending on the status of connection between the central control terminal 100, the repeater 400, and/or the server 200, or because the content may be a pre-recorded performance rather than a live stream.

The remote location control signal 722 may indicate a current time point at which a remote location control signal is being transmitted within the running time of the streaming performance. The corresponding time point may be indicated as a remote location control signal transmission time point 54.

In this regard, the performance progress time point 51 and the streaming time point 53 may be different from each other. This is because a delay may occur depending on the Internet connection status or the like as the performance performed in real time is transmitted to the repeater 400 based on the server 200.

Similarly, the streaming time point 53 and the remote location control signal transmission time point 54 may also be different from each other. This is because the transmission sources of a streaming video playback signal and a lighting-based visual production control signal for the streaming video may be different from each other.

In addition, the respective streaming time points 53 and 55 of the first repeater and the second repeater may be different from each other and the respective remote location control signal transmission time points 54 and 56 thereof may be different from each other, depending on the Internet connection status or the like at the remote locations where the respective repeaters are located.

In addition, in an embodiment, the computing system 1000 may display remote site information 720 and 730 via the administrator interface 500.

First remote site information 720 for the first repeater and second remote site information 730 for the second repeater may be images and/or videos obtained by capturing the respective remote locations using cameras included in the respective repeaters.

The first and second remote site information 720 and 730 may include streaming videos being played and/or lighting-based visual production scenes made by the lighting devices 300 at the respective remote locations. This allows the administrator to grasp the on-site situation of each remote location.

In an embodiment, the computing system 1000 may remotely control the first repeater based on the obtained status information and/or performance status information.

In more detail, in an embodiment, the computing system 1000 may perform remote control with respect to at least one of 1) the power status of a repeater, 2) the Internet connection status of a repeater, and 3) synchronization between a streaming video and a streaming control signal.

In order to perform the above-described remote control, in an embodiment, the computing system 1000 may use a dedicated monitoring channel connected to each repeater 400.

In detail, each repeater 400 may periodically transmit, via the dedicated monitoring channel, the playback status (e.g., ‘playing’, ‘stopped’) of a streaming video being played by the repeater 400 to the central control terminal 100 or the service providing server 200.

Accordingly, the application 111 may receive the playback status of each remote location in real time via the dedicated monitoring channel, and when a preset abnormal signal, such as 'stopped' or 'buffering', is detected, it may receive and obtain a trigger signal from the corresponding repeater 400.

When the above-described trigger is obtained, the problem at the corresponding remote location may be immediately displayed as an ‘alert’ on the administrator interface 500.

In an embodiment, the computing system 1000 may remotely control the power of the first repeater to be on and/or off based on the status information of the first repeater.

For example, when the administrator determines based on the status information of the first repeater that an error has occurred in the first repeater, the administrator may remotely control the power of the first repeater and reboot the first repeater.

In addition, in an embodiment, the computing system 1000 may remotely control the Internet connection between the first repeater and the server 200 based on the status information of the first repeater.

In this regard, the first repeater may perform a self-recovery process before being remotely controlled. For example, restarting of an internal process responsible for transmitting control signals, reconnection to the network, system rebooting, and the like may be performed.

In addition, in an embodiment, the computing system 1000 may detect at least one repeater where a temporal discrepancy occurs between an on-site performance time point and a streaming video time point and/or between the streaming video time point and a remote location control signal, based on the status information.

In addition, in an embodiment, the computing system 1000 may remotely control each repeater in order to synchronize (match execution timing) between the performance time point and the streaming video time point and/or between the streaming video time point and the remote location control signal with respect to the detected repeater.

Therefore, in an embodiment, the computing system 1000 may perform the sync process between the streaming video and the remote location control signal based on the status information.

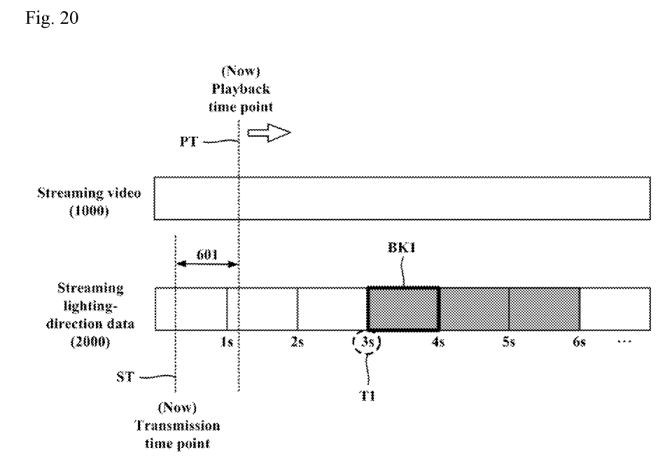

FIG. 20 is a conceptual diagram for illustrating a sync process according to an embodiment of the present disclosure.

In an embodiment, the computing system 1000 may receive a current playback time point PT of a streaming video 3000 being played by the first repeater.

In this regard, streaming lighting-based visual production data 2000 corresponding to the streaming video 3000 being played may be transmitted from the first repeater. The streaming lighting-based visual production data 2000 refers to lighting-based visual production data synchronized with the streaming video (lighting-based visual production synchronization data).

The streaming lighting-based visual production data 2000 being transmitted may be at a signal transmission time point that is slightly behind or ahead of the current playback time point PT of the streaming video 3000. For example, the application 111 may be transmitting a signal at a current transmission time point ST, which is behind the current playback time point PT by a first time 601.

In addition, in an embodiment, the computing system 1000 may determine a lighting-based visual production block for a first future time point T1, which is a time point ahead of the received current playback time point PT.

In this regard, the lighting-based visual production block according to an embodiment may refer to a section that is included in the streaming lighting-based visual production synchronization data 2000, and where a lighting pattern is produced for each unit time.

In addition, in an embodiment, the computing system 1000 may determine whether the current playback time point PT and the first future time point T1 match.

When the current playback time point PT matches the first future time point T1, the computing system 1000 may control transmission of a lighting-based visual production control signal such that light is emitted according to a first lighting-based visual production block BK1 at the first future time point T1, thereby minimizing a temporal discrepancy between the video and the visual production.

Additionally, when the repeater is rebooted according to the self-recovery process, the application 111 may compare a timestamp recorded at the time of occurrence of the error with the current time to calculate the elapsed time during which the system was stopped due to the error, and immediately jump the playback time point to a corresponding segment of the lighting-based visual production synchronization data.

In one example, in another embodiment, the computing system 1000 may convert the on-site visual production data into the remote location visual production data according to environment information (e.g., seat layout and/or illuminance) of the remote location where the repeater 400 is located.

In this regard, the environment information may include playback status information and/or operational status information of the repeater 400. The playback status information may indicate the playback status of the streaming video and the streaming lighting-based visual production control signal transmitted by the repeater 400, and the operational status information may indicate physical environmental conditions such as power, communication status, number of connected lighting devices, structure of a remote site, seats, illuminance, and the like of the repeater 400.

In particular, in another embodiment, the computing system 1000 may periodically measure ambient brightness of the remote location through an illuminance sensor mounted in the repeater 400, and may automatically convert and correct the on-site visual production data based on the measured illuminance value. The automatically converted and corrected data may become the remote location visual production data.

In more detail, the repeater 400 may measure an illuminance value and transmit the data to the central control terminal 100 and/or the server 200 in real time together with the unique identifier ID of the repeater 400. Accordingly, in another embodiment, the computing system 1000 may perform a process of converting, correcting, and determining the lighting-based visual production synchronization data transmitted to the remote location where the corresponding repeater 400 is located, by comparing and analyzing the data against a pre-stored illuminance-visual production conversion matrix.

In this regard, a plurality of illuminance thresholds and visual production data conversion rules corresponding to each threshold may be defined in the illuminance-visual production conversion matrix. In addition, the illuminance-visual production transformation matrix may include an alternative visual production library and/or a specific parameter adjustment process.

In more detail, in another embodiment, when the measured illuminance value is equal to or greater than a preset threshold, the computing system 1000 may determine that the remote location is bright and modify at least one parameter included in the lighting-based visual production synchronization data.

For example, in the case of the above-described example, the visual production data may be automatically corrected in a manner of expressing a clear pattern rather than a minute color change by removing a conversion value for 'color' from the lighting-based visual production synchronization data and adding a value for 'effect' to the data. Alternatively, the visual production data may be corrected by adjusting the brightness of 'color' (i.e., via a specific parameter adjustment process).

Conversely, when the measured illuminance value is less than a preset threshold, the remote location may be determined to be dark, and similarly, at least one parameter included in the lighting-based visual production synchronization data may be modified.

For example, the visual production data may be automatically corrected by upwardly adjusting the value of 'brightness' among the lighting-based visual production synchronization data.

The entire processes and results of converting or adjusting the visual production data according to the illuminance value may be displayed in real time on the administrator interface 500 of the application 111.

This allows the administrator to intuitively grasp which remote location the visual production data is being converted and how the visual production data is being converted and manage the conversion.

The embodiments according to the present disclosure described above may be implemented in the form of program instructions executable through various computer components and recorded on a computer-readable recording medium. The computer-readable recording medium may include program instructions, data files, data structures, and the like alone or in combination. The program instructions recorded in the computer-readable recording medium may be specially designed and configured for the present disclosure or may be known and available to those skilled in the field of computer software. Examples of the computer-readable recording medium include magnetic media such as a hard disk, a floppy disk and a magnetic tape, optical recording media such as a CD-ROM and a DVD, magneto-optical media such as a floptical disk, and hardware devices specially configured to store and execute program instructions such as a ROM, a RAM, a flash memory, and the like. Examples of program instructions include not only machine language codes such as those generated by a compiler, but also high-level language codes executable by a computer using an interpreter or the like. The hardware devices may be modified into one or more software modules to perform processing according to the present disclosure, and vice versa.

The specific implementations described herein are merely embodiments, and do not limit the scope of the present disclosure in any way. For the sake of brevity of the present document, descriptions of existing electronic components, control systems, software, and other functional aspects of the systems may be omitted. In addition, the line connections or connection members between the components illustrated in the drawings are intended to exemplarily represent functional connections and/or physical or circuit connections, and in actual devices, may be represented as various functional connections, physical connections, or circuit connections that are replaceable or additional. In addition, when there is no specific mention such as "essential", "important", or the like, a component may not be an essential component for the application of the present disclosure.

In addition, although the detailed description of the present disclosure has been provided with reference to preferred embodiments of the present disclosure, those skilled in the art or those having ordinary knowledge in the art will understand that various modifications and changes may be made to the present disclosure without departing from the spirit and technical scope of the present disclosure as set forth in the claims below. Therefore, the technical scope of the present disclosure should not be limited to the contents in the detailed description of the present document, but should be determined by the claims.

1. A method for a computing system to control lighting devices, the method comprising: obtaining video data including shape information and rendering color code information of each of a plurality of lighting devices respectively paired with different seats;
storing a dataset by associating the shape information and the rendering color code information with device identification information of each of the lighting devices;
training an image analysis model configured to, when the video data is input, extract the shape information and the rendering color code information and output the device identification information using the dataset;
automatically determining the device identification information of each of the plurality of lighting devices by applying the image analysis model to the video data; extracting lighting pattern information corresponding to the determined device identification information, wherein the lighting pattern information includes at least one of a color parameter, a brightness parameter, and an effect parameter;
accumulating the lighting pattern information as pick-up information by matching the lighting pattern information with a time stamp indicating a pick-up time point for the extracted lighting pattern information;
correcting at least one parameter of the accumulated pick-up information through a lighting pattern management interface; and
transmitting, to the plurality of lighting devices, a control signal including an instruction for causing the lighting devices to emit light based on the corrected pick-up information, through a repeater located at a remote location.

2. The method of claim 1, wherein the lighting pattern information includes the color parameter, an HSL parameter, and the effect parameter,
wherein at least one of a lighting color, a lighting duration, a lighting brightness, and a lighting effect is indicated based on the plurality of parameters.

3. The method of claim 1, wherein the image analysis model is pre-trained using a dataset including the shape information of each lighting device mapped to a rendering color code pre-defined corresponding to the shape,
wherein the training of the image analysis model further includes:
setting, as a commercial tag, lighting pattern information that has been extracted at least a preset number of times for a first lighting device among the plurality of lighting devices; and
pre-training the image analysis model based on the commercial tag.

4. The method ofclaim 1, wherein the control signal includes a device ID,
wherein each of the plurality of lighting devices receiving the control signal from the repeater located at the remote location is configured to emit light in response to the control signal only when a device ID prestored therein matches the device ID included in the control signal.

5. The method of claim 1, wherein the lighting pattern management interface is configured to:
display a timeline view representing lighting pattern information for each pick-up time point accumulated in chronological order, on a time axis;
highlight the pick-up information when a difference value between the pick-up information and pre-stored standard data exceeds a threshold value; and
provide a correction value automatically determined by at least one artificial intelligence model based on a preset rendering color code when the highlighted pick-up information is selected.

6. The method of claim 1, wherein the transmitting of the control signal to the plurality of lighting devices includes:
extracting a local time stamp included in the pick-up information;
extracting a streaming time stamp mapped to a live video played at a remote location;
calculating a synchronization time point by calculating an offset between the extracted

7. A method for a computing system to control lighting devices, the method comprising: obtaining on-site seat information for an on-site performance;
obtaining remote location seat information for a first remote location where the on-site performance is streamed;
determining and displaying, from among the on-site seat information, at least one target seat at which visual production to be applied to the first remote location is performed;
converting on-site visual production data for the at least one target seat into remote location visual production data optimized for the first remote location; and remotely controlling a repeater located at each of at least one remote location including the first remote location based on the converted remote location visual production data.

8. The method of claim 7, wherein the determining and displaying of the at least one target seat includes:
analyzing a shape similarity between at least a portion of the on-site seat information and the remote location seat information, wherein the shape similarity is based on at least one of an angle of each remote location seat, a number of seats, a seat density of a remote location block including a plurality of remote location seats, and a horizontal-to-vertical ratio; and
determining, as the target seats, seats included in a first block having the shape similarity equal to or greater than a preset ratio among a plurality of candidate blocks in the on-site seat information, wherein a block is a set of at least two seats.

9. The method of claim 7, wherein the converting of the on-site visual production data for the at least one target seat into the remote location visual production data includes performing a visual production shape scaling operation by comparing seat parameters of an on-site block including the at least one target seat for the on-site performance with seat parameters of a remote location block including a plurality of seats for a remote location performance,
wherein the seat parameters include at least one of a number of seats, a number of rows, and a number of columns of the on-site seat information or the remote location seat information

10. The method of claim 9, wherein the performing of the visual production shape scaling operation includes:
calculating a resampling ratio based on a difference between the seat parameters of the on-site block and the remote location block; and
proportionally deleting or duplicating at least a portion of row data or column data included in the on-site visual production data according to the calculated resampling ratio.

11. The method of claim 9, wherein the performing of the visual production shape scaling operation further includes:
extracting, from the on-site visual production data, visual production values of data associated with seats adjacent to seats corresponding to the deleted or duplicated row or column data; and
generating the remote location visual production data by performing correction on the on-site visual production data based on the extracted visual production values,
wherein the visual production value associated with each adjacent seat includes at least one of a lighting color, a lighting brightness, and a lighting effect of a lighting device corresponding to the seat and configured to emit light according to the visual production data.

12. The method of claim 7, wherein the converting of the on-site visual production data for the at least one target seat into the remote location visual production data includes:
mapping a plurality of seats within an on-site block including the at least one target seat to a plurality of seats within a remote location block in a 1:1 manner; and
generating the remote location visual production data by applying a visual production value of each of the plurality of seats within the on-site block to a visual production value of corresponding one of the plurality of seats within the remote location block based on the 1:1 mapping,
wherein section control for manifesting a visual production pattern of the on-site block at the remote location block is set in the remote location visual production data based on the 1:1 mapping.

13. The method of claim 7, wherein the converting of the on-site visual production data for the at least one target seat into the remote location visual production data includes:
detecting a dark interval included in on-site visual production data of a single seat;
generating a visual production correction value based on a duration of the detected dark interval and visual production values immediately before and after the dark interval; and
generating the remote location visual production data by replacing the dark interval with the visual production correction value.

14. The method of claim 13, wherein the generating of the remote location visual production data by replacing the dark interval with the visual production correction value includes:
determining the lighting-based visual production value immediately before the dark interval as a first visual production value;
determining the lighting-based visual production value immediately after the dark interval as a second visual production value;
generating a visual production correction value for continuously transitioning from the first visual production value to the second visual production value over the entire duration of the dark interval; and
generating the remote location visual production data by replacing the dark interval with the generated visual production correction value.

15. A system for controlling lighting devices, the system comprising: a central control terminal operatively coupled to:
at least one AI camera;
at least one repeater; and
a plurality of lighting devices,
wherein the central control terminal includes: at least one memory; and at least one processor configured to read at least one application stored in the memory and control the plurality of lighting devices using the AI camera,
wherein the processor of the central control terminal is configured to operate in response to instructions for:
obtaining video data including shape information and rendering color code information of each of the plurality of lighting devices respectively paired with different seats;
storing a dataset by associating the shape information and the rendering color code information with device identification information of each of the lighting devices;
training an image analysis model configured to, when the video data is input, extract the shape information and the rendering color code information and output the device identification information using the dataset;
automatically determining the device identification information of each of the plurality of lighting devices by applying the image analysis model to the video data;
extracting lighting pattern information corresponding to the determined device identification information, wherein the lighting pattern information includes at least one of a color parameter, a brightness parameter, and an effect parameter;
accumulating the lighting pattern information as pick-up information by matching the lighting pattern information with a time stamp indicating a pick-up time point for the extracted lighting pattern information;
obtaining on-site seat information for an on-site performance and remote location seat information for a first remote location where the on-site performance is streamed;
determining and displaying, from among the on-site seat information, at least one target seat at which visual production to be applied to the first remote location is performed;
converting on-site visual production data for the at least one target seat or the pick-up information into remote location visual production data optimized for the first remote location;
correcting at least one parameter of the accumulated pick-up information through a lighting pattern management interface; and
transmitting, to the plurality of lighting devices, a control signal including an instruction for causing the lighting devices to emit light based on the corrected pick-up information or the remote location visual production data, through a repeater located at a remote location.

16. The system of claim 15, wherein the repeater includes:
a receiver configured to obtain at least one of the remote location visual production data, a streaming video, and a lighting-based visual production control signal corresponding to the streaming video from the central control terminal or a server connected to the central control terminal; and
a transmitter configured to transmit, to the central control terminal or a server connected thereto, playback status information for the streaming video and the lighting-based visual production control signal corresponding to the streaming video.

17. The system of claim 16, wherein the repeater is configured to generate a trigger signal and transmit the trigger signal to the central control terminal or the server connected to the central control terminal when a preset abnormal signal is detected in the playback status information.

18. The system of claim 17, wherein the application is configured to:
display, on an administrator interface, status information of the repeater that transmitted the trigger signal as an ‘alert’ upon receiving the trigger signal from the repeater; and
perform at least one remote control operation selected from power control, network reconnection, and sync control for the repeater associated with the displayed ‘alert’.

19. The system of claim 18, wherein the repeater is configured to obtain a remote control command including a sync control command for performing synchronization between a current playback time point of the streaming video and a current transmission time point of the lighting-based visual production control signal.
